(19) United States
(12) Patent Application Publication
(10) Pub. No.: US 2026/0003778 A1
(43) Pub. Date: Jan. 1, 2026

(54) SYSTEMS AND METHODS FOR COMPRESSING, DECOMPRESSING, AND PROCESSING DATA FOR USE BY MACHINE LEARNING MODELS

(71) Applicant: Meta Platforms Technologies, LLC, Menlo Park, CA (US)

(72) Inventors: Ali Shafiee Ardestani, San Jose, CA (US); Kyong Ho Lee, Los Altos, CA (US); Harshit Khaitan, Fremont, CA (US); Rawan Naous, Pleasanton, CA (US); Sruthikesh Surineni, Austin, TX (US)

(21) Appl. No.: 19/228,714

(22) Filed: Jun. 4, 2025

Related U.S. Application Data
(60) Provisional application No. 63/665,968, filed on Jun. 28, 2024.
(60) Provisional application No. 63/665,536, filed on Jun. 28, 2024.

(51) Int. Cl. G06F 12/02

(52) U.S. Cl. CPC G06F 12/023; G06F 12/0207; G06F 2212/1044

(57) ABSTRACT

Systems and methods for tensor cache compression and/or decompression are disclosed. An example method includes receiving a tensor or dynamically generated data. The example method includes compressing the tensor (or the dynamically generated data) by applying a compression scheme to values of the tensor (or dynamically generated data). The example method also includes storing a compressed tensor into a tensor cache (or compressed dynamically generated data into a respective cache). The example method includes reading the compressed tensor from the tensor cache (or the compressed dynamically generated data from the respective cache), and decompressing the compressed tensor (or compressed dynamically generated data) by applying a decompression scheme to values of the compressed tensor (or compressed dynamically generated data). The example method further includes forwarding a decompressed tensor (or decompressed dynamically generated data) to a compute unit.

### RELATED APPLICATION

This application claims priority to U.S. Provisional Application Ser. No. 63/655,968, filed Jun. 4, 2024, entitled “Tensor Cache Compression” and U.S. Provisional Application Ser. No. 63/665,536, filed Jun. 28, 2024, entitled “Spatially Distributed Computation,” each of which is incorporated herein by reference.

### TECHNICAL FIELD

This relates generally to data processing, and more specifically, techniques for compressing, decompressing, and/or processing data provided to large language models.

### BACKGROUND

Machine learning models, such as large language models, can have context specific data per application. The context specific data can make it difficult to share a machine learning model between applications. Additionally, existing techniques for reducing computational and memory requirements of machine learning models can generate quantization errors. Moreover, existing quantization techniques can limit future applications of machine learning models. Further, existing hardware implementations utilize A8W8 quantization scheme, which limit performance and precision.

As such, there is a need to address one or more of the above-identified challenges. A brief summary of solutions to the issues noted above are described below.

### SUMMARY

The system and methods disclosed herein can utilize key tensor and value tensor cache compression to allow for one machine learning model (e.g., one large language model) to be shared between multiple applications. For example the system and methods disclosed herein can use key tensor and value tensor cache compression to account for large language model context per application. The system and methods disclosed herein can store key tensor and value tensor cache in 16 b, which alleviates the quantization error induced by weight quantization. Moreover, the systems and methods disclosed herein may allow for batching for edge-devices, which would increase key tensor and value tensor cache sizes.

The system and methods disclosed herein reduce 16 b activation to 8 b or lower. The system and methods disclosed herein use non-uniform compression in at least two forms: private exponent and shared exponent schemes. In private exponent compression an INT16 can be compressed to 5 b or 8 b. For INT8, compression to 5 b is supported. Non-uniform compression of private exponent is used to keep a floating point-like number for the input integer. For int16→5 b, a sign bit (1 b) and exponent bits (4 b) with one implicit hidden bit can be retained. For int8→5 b, a sign bit (1 b), exponent bits (3 b), and one mantissa bit can be retained. For int16→8 b, a sign bit (1 b), exponent bits (4 b), and three mantissa bits can be retained. In the shared exponent scheme a block of numbers share the same exponent. The shared exponent can be the maximum exponent of the input number when compressed with the private exponent scheme. In some embodiments, the compression scheme fixes the block size to 4 numbers. In some embodiments, because information to indicate which numbers have the maximum exponent is not retained, there are no implicit hidden bits. The systems and methods disclosed herein can include two high-level modifications into the architecture: (1) adding compressor to cluster activation smart direct memory access and (2) adding decompressor to weight and act smart direct memory access. The systems and method disclosed herein sustain 16 B/cycle throughput at all the involved direct memory access ports.

In accordance with one embodiment, a non-transitory, computer-readable storage medium including executable instructions for tensor cache compression and/or decompression is disclosed. The executable instructions, when executed by one or more processors, cause the one or more processors to perform receiving a tensor or dynamically generated data. The executable instructions, when executed by one or more processors, further cause the one or more processors to perform compressing the tensor (or the dynamically generated data) by applying a compression scheme to values of the tensor (or dynamically generated data) to form a compressed tensor (or compressed dynamically generated data). The executable instructions, when executed by one or more processors, further cause the one or more processors to perform storing the compressed tensor into a tensor cache (or the compressed dynamically generated data into a respective cache). The executable instructions, when executed by one or more processors, further cause the one or more processors to perform reading the compressed tensor from the tensor cache (or the compressed dynamically generated data from the respective cache), and decompressing the compressed tensor (or compressed dynamically generated data) by applying a decompression scheme to values of the compressed tensor (or compressed dynamically generated data) to form a decompressed tensor (or a decompressed dynamically generated data). The executable instructions, when executed by one or more processors, further cause the one or more processors to perform forwarding the decompressed tensor (or the decompressed dynamically generated data) to a compute unit.

In accordance with another embodiment, a method for tensor cache compression and/or decompression is disclosed. The method includes receiving a tensor or dynamically generated data. The method includes compressing the tensor (or the dynamically generated data) by applying a compression scheme to values of the tensor (or dynamically generated data) to form a compressed tensor (or compressed dynamically generated data). The method includes storing the compressed tensor into a tensor cache (or the compressed dynamically generated data into a respective cache). The method includes reading the compressed tensor from the tensor cache (or the compressed dynamically generated data from the respective cache), and decompressing the compressed tensor (or compressed dynamically generated data) by applying a decompression scheme to values of the compressed tensor (or compressed dynamically generated data) to form a decompressed tensor (or a decompressed dynamically generated data). The method includes forwarding the decompressed tensor (or the decompressed dynamically generated data) to a compute unit.

In accordance with yet another embodiment, a system for tensor cache compression and/or decompression is disclosed. The system includes at least one wearable device, memory including one or more programs that are configured to be executed by one or more processors, and one or more processors in communication with the at least one wearable device. The one or more programs include instructions for receiving a tensor or dynamically generated data. The one or more programs include instructions for compressing the tensor (or the dynamically generated data) by applying a compression scheme to values of the tensor (or dynamically generated data) to form a compressed tensor (or compressed dynamically generated data). The one or more programs include instructions for storing the compressed tensor into a tensor cache (or the compressed dynamically generated data into a respective cache). The one or more programs include instructions for reading the compressed tensor from the tensor cache (or the compressed dynamically generated data from the respective cache), and decompressing the compressed tensor (or compressed dynamically generated data) by applying a decompression scheme to values of the compressed tensor (or compressed dynamically generated data) to form a decompressed tensor (or a decompressed dynamically generated data). The one or more programs include instructions for forwarding the decompressed tensor (or the decompressed dynamically generated data) to a compute unit.

The systems and methods disclosed herein can utilize 16-bit weights to increase precision and improve model performance. The systems and methods disclosed herein split the computations over two sub-arrays (SAs) in parallel. Two SAs (for example, SA0 and SA1) can work in parallel to perform A16W8 to create A16W16 in a spatial manner. In some embodiments, each SA generates two combinations that make up the A16W16 (A16*W8_LSB, A16*W8_MSB). The outputs from SA1 can be shifted left by 8 bits and then added to SA0 using the Natural language understanding (NLU) reduction stage. In some embodiments, the systems and methods disclosed herein divides weights into LSB and MSB across SA0 and SA1 weight RF. The input A16 activations can be broadcasted to both SA0 and SA1, which are both working with the same weights. Shifting the SA1 outputs by 8 may requires larger adders in the NLU reduction stage and minor changes to the NLU frontend to support W16.

In accordance with one embodiment, a non-transitory, computer-readable storage medium including executable instructions for spatially distributed computation is disclosed. The executable instructions, when executed by one or more processors, cause the one or more processors to perform splitting a weight for a computation into a plurality of sub-weights. The executable instructions, when executed by one or more processors, further cause the one or more processors to perform sending the plurality of sub-weights to a plurality of computation units and performing, by each of the plurality of computation units using a corresponding one of the plurality of sub-weights, a portion of the computation. The executable instructions, when executed by one or more processors, further cause the one or more processors to perform combining outputs of the plurality of computation units to produce a final output for the computation.

In accordance with another embodiment, a method for spatially distributed computation is disclosed. The method includes splitting a weight for a computation into a plurality of sub-weights. The method include sending the plurality of sub-weights to a plurality of computation units and performing, by each of the plurality of computation units using a corresponding one of the plurality of sub-weights, a portion of the computation. The method includes combining outputs of the plurality of computation units to produce a final output for the computation.

In accordance with yet another embodiment, a system for spatially distributed computation is disclosed. The system includes at least one wearable device, memory including one or more programs that are configured to be executed by one or more processors, and one or more processors in communication with the at least one wearable device. The one or more programs include instructions for splitting a weight for a computation into a plurality of sub-weights. The one or more programs include instructions for sending the plurality of sub-weights to a plurality of computation units and performing, by each of the plurality of computation units using a corresponding one of the plurality of sub-weights, a portion of the computation. The one or more programs include instructions for combining outputs of the plurality of computation units to produce a final output for the computation.

Instructions that cause performance of the methods and operations described herein can be stored on a non-transitory computer readable storage medium. The non-transitory computer-readable storage medium can be included on a single electronic device or spread across multiple electronic devices of a system (computing system). A non-exhaustive of list of electronic devices that can either alone or in combination (e.g., a system) perform the method and operations described herein include an extended-reality (XR) headset/glasses (e.g., a mixed-reality (MR) headset or a pair of augmented-reality (AR) glasses as two examples), a wrist-wearable device, an intermediary processing device, a smart textile-based garment, etc. For instance, the instructions can be stored on a pair of AR glasses or can be stored on a combination of a pair of AR glasses and an associated input device (e.g., a wrist-wearable device) such that instructions for causing detection of input operations can be performed at the input device and instructions for causing changes to a displayed user interface in response to those input operations can be performed at the pair of AR glasses. The devices and systems described herein can be configured to be used in conjunction with methods and operations for providing an XR experience. The methods and operations for providing an XR experience can be stored on a non-transitory computer-readable storage medium.

The devices and/or systems described herein can be configured to include instructions that cause the performance of methods and operations associated with the presentation and/or interaction with an extended-reality (XR) headset. These methods and operations can be stored on a non-transitory computer-readable storage medium of a device or a system. It is also noted that the devices and systems described herein can be part of a larger, overarching system that includes multiple devices. A non-exhaustive of list of electronic devices that can, either alone or in combination (e.g., a system), include instructions that cause the performance of methods and operations associated with the presentation and/or interaction with an XR experience include an extended-reality headset (e.g., a mixed-reality (MR) headset or a pair of augmented-reality (AR) glasses as two examples), a wrist-wearable device, an intermediary processing device, a smart textile-based garment, etc. For example, when an XR headset is described, it is understood that the XR headset can be in communication with one or more other devices (e.g., a wrist-wearable device, a server, intermediary processing device) which together can include instructions for performing methods and operations associated with the presentation and/or interaction with an extended-reality system (i.e., the XR headset would be part of a system that includes one or more additional devices). Multiple combinations with different related devices are envisioned, but not recited for brevity.

The features and advantages described in the specification are not necessarily all inclusive and, in particular, certain additional features and advantages will be apparent to one of ordinary skill in the art in view of the drawings, specification, and claims. Moreover, it should be noted that the language used in the specification has been principally selected for readability and instructional purposes.

Having summarized the above example aspects, a brief description of the drawings will now be presented.

### BRIEF DESCRIPTION OF THE DRAWINGS

For a better understanding of the various described embodiments, reference should be made to the Detailed Description below, in conjunction with the following drawings in which like reference numerals refer to corresponding parts throughout the figures.

FIG. 1 is a diagram of an exemplary tensor cache, in accordance with some embodiments.

FIG. 2 illustrates exemplary pseudo-code for tensor compression and decompression with a tensor cache, in accordance with some embodiments.

FIG. 3 is a diagram of a decode phase of an attention block of a large language model, in accordance with some embodiments.

FIG. 4 is a diagram of exemplary private exponent compression schemes, in accordance with some embodiments.

FIG. 5 is a diagram of exemplary shared exponent compression schemes, in accordance with some embodiments.

FIG. 6 is a table of compression schemes, in accordance with some embodiments.

FIG. 7 is a diagram of inputs and outputs of the compression schemes, in accordance with some embodiments.

FIG. 8 is a flow diagram of an exemplary method for tensor cache compression, in accordance with some embodiments.

FIG. 9 is an example a large language model, in accordance with some embodiments.

FIG. 10 is an example architecture for a MAC unit pair, in accordance with some embodiments.

FIG. 11 is a diagram of a larger bit size activation, in accordance with some embodiments.

FIG. 12 is a diagram of an architecture for MAC unit pair supporting larger bit sizes, in accordance with some embodiments.

FIG. 13 is a diagram of an architecture for MAC unit pair with weight duplication, in accordance with some embodiments.

FIG. 14 is a diagram of an example 8 b mode, in accordance with some embodiments.

FIGS. 15A and 15B are diagrams of an example 16 b mode, in accordance with some embodiments.

FIG. 16 is a diagram of example storage of weight values, in accordance with some embodiments.

FIGS. 17A and 17B illustrate example activation transposing, in accordance with some embodiments.

FIG. 18 illustrates an example weight transposing, in accordance with some embodiments.

FIGS. 19A and 19B illustrate an example convolutions including a dense convolution and a depthwise convolution, in accordance with some embodiments.

FIG. 20 illustrates another example depthwise convolution, in accordance with some embodiments.

FIG. 21 shows an example method flow chart for spatially distributed computation, in accordance with some embodiments.

FIGS. 22A, 22B, 22C-1, and 22C-2 illustrate example MR and AR systems, in accordance with some embodiments.

In accordance with common practice, the various features illustrated in the drawings may not be drawn to scale. Accordingly, the dimensions of the various features may be arbitrarily expanded or reduced for clarity. In addition, some of the drawings may not depict all of the components of a given system, method, or device. Finally, like reference numerals may be used to denote like features throughout the specification and figures.

### DETAILED DESCRIPTION

Numerous details are described herein to provide a thorough understanding of the example embodiments illustrated in the accompanying drawings. However, some embodiments may be practiced without many of the specific details, and the scope of the claims is only limited by those features and aspects specifically recited in the claims. Furthermore, well-known processes, components, and materials have not necessarily been described in exhaustive detail so as to avoid obscuring pertinent aspects of the embodiments described herein.

### Overview

Embodiments of this disclosure can include or be implemented in conjunction with various types of extended-realities (XRs) such as mixed-reality (MR) and augmented-reality (AR) systems. MRs and ARs, as described herein, are any superimposed functionality and/or sensory-detectable presentation provided by MR and AR systems within a user's physical surroundings. Such MRs can include and/or represent virtual realities (VRs) and VRs in which at least some aspects of the surrounding environment are reconstructed within the virtual environment (e.g., displaying virtual reconstructions of physical objects in a physical environment to avoid the user colliding with the physical objects in a surrounding physical environment). In the case of MRs, the surrounding environment that is presented through a display is captured via one or more sensors configured to capture the surrounding environment (e.g., a camera sensor, time-of-flight (ToF) sensor). While a wearer of an MR headset can see the surrounding environment in full detail, they are seeing a reconstruction of the environment reproduced using data from the one or more sensors (i.e., the physical objects are not directly viewed by the user). An MR headset can also forgo displaying reconstructions of objects in the physical environment, thereby providing a user with an entirely VR experience. An AR system, on the other hand, provides an experience in which information is provided, e.g., through the use of a waveguide, in conjunction with the direct viewing of at least some of the surrounding environment through a transparent or semi-transparent waveguide(s) and/or lens(es) of the AR glasses. Throughout this application, the term “extended reality (XR)” is used as a catchall term to cover both ARs and MRs. In addition, this application also uses, at times, a head-wearable device or headset device as a catchall term that covers XR headsets such as AR glasses and MR headsets.

As alluded to above, an MR environment, as described herein, can include, but is not limited to, non-immersive, semi-immersive, and fully immersive VR environments. As also alluded to above, AR environments can include marker-based AR environments, markerless AR environments, location-based AR environments, and projection-based AR environments. The above descriptions are not exhaustive and any other environment that allows for intentional environmental lighting to pass through to the user would fall within the scope of an AR, and any other environment that does not allow for intentional environmental lighting to pass through to the user would fall within the scope of an MR.

The AR and MR content can include video, audio, haptic events, sensory events, or some combination thereof, any of which can be presented in a single channel or in multiple channels (such as stereo video that produces a three-dimensional effect to a viewer). Additionally, AR and MR can also be associated with applications, products, accessories, services, or some combination thereof, which are used, for example, to create content in an AR or MR environment and/or are otherwise used in (e.g., to perform activities in) AR and MR environments.

Interacting with these AR and MR environments described herein can occur using multiple different modalities and the resulting outputs can also occur across multiple different modalities. In one example AR or MR system, a user can perform a swiping in-air hand gesture to cause a song to be skipped by a song-providing application programming interface (API) providing playback at, for example, a home speaker.

A hand gesture, as described herein, can include an in-air gesture, a surface-contact gesture, and or other gestures that can be detected and determined based on movements of a single hand (e.g., a one-handed gesture performed with a user's hand that is detected by one or more sensors of a wearable device (e.g., electromyography (EMG) and/or inertial measurement units (IMUs) of a wrist-wearable device, and/or one or more sensors included in a smart textile wearable device) and/or detected via image data captured by an imaging device of a wearable device (e.g., a camera of a head-wearable device, an external tracking camera setup in the surrounding environment)). “In-air” generally includes gestures in which the user's hand does not contact a surface, object, or portion of an electronic device (e.g., a head-wearable device or other communicatively coupled device, such as the wrist-wearable device), in other words the gesture is performed in open air in 3D space and without contacting a surface, an object, or an electronic device. Surface-contact gestures (contacts at a surface, object, body part of the user, or electronic device) more generally are also contemplated in which a contact (or an intention to contact) is detected at a surface (e.g., a single- or double-finger tap on a table, on a user's hand or another finger, on the user's leg, a couch, a steering wheel). The different hand gestures disclosed herein can be detected using image data and/or sensor data (e.g., neuromuscular signals sensed by one or more biopotential sensors (e.g., EMG sensors) or other types of data from other sensors, such as proximity sensors, ToF sensors, sensors of an IMU, capacitive sensors, strain sensors) detected by a wearable device worn by the user and/or other electronic devices in the user's possession (e.g., smartphones, laptops, imaging devices, intermediary devices, and/or other devices described herein).

The input modalities as alluded to above can be varied and are dependent on a user's experience. For example, in an interaction in which a wrist-wearable device is used, a user can provide inputs using in-air or surface-contact gestures that are detected using neuromuscular signal sensors of the wrist-wearable device. In the event that a wrist-wearable device is not used, alternative and entirely interchangeable input modalities can be used instead, such as camera(s) located on the headset/glasses or elsewhere to detect in-air or surface-contact gestures or inputs at an intermediary processing device (e.g., through physical input components (e.g., buttons and trackpads)). These different input modalities can be interchanged based on both desired user experiences, portability, and/or a feature set of the product (e.g., a low-cost product may not include hand-tracking cameras).

While the inputs are varied, the resulting outputs stemming from the inputs are also varied. For example, an in-air gesture input detected by a camera of a head-wearable device can cause an output to occur at a head-wearable device or control another electronic device different from the head-wearable device. In another example, an input detected using data from a neuromuscular signal sensor can also cause an output to occur at a head-wearable device or control another electronic device different from the head-wearable device. While only a couple examples are described above, one skilled in the art would understand that different input modalities are interchangeable along with different output modalities in response to the inputs.

Specific operations described above may occur as a result of specific hardware. The devices described are not limiting and features on these devices can be removed or additional features can be added to these devices. The different devices can include one or more analogous hardware components. For brevity, analogous devices and components are described herein. Any differences in the devices and components are described below in their respective sections.

As described herein, a processor (e.g., a central processing unit (CPU) or microcontroller unit (MCU)), is an electronic component that is responsible for executing instructions and controlling the operation of an electronic device (e.g., a wrist-wearable device, a head-wearable device, a handheld intermediary processing device (HIPD), a smart textile-based garment, or other computer system). There are various types of processors that may be used interchangeably or specifically required by embodiments described herein. For example, a processor may be (i) a general processor designed to perform a wide range of tasks, such as running software applications, managing operating systems, and performing arithmetic and logical operations; (ii) a microcontroller designed for specific tasks such as controlling electronic devices, sensors, and motors; (iii) a graphics processing unit (GPU) designed to accelerate the creation and rendering of images, videos, and animations (e.g., VR animations, such as three-dimensional modeling); (iv) a field-programmable gate array (FPGA) that can be programmed and reconfigured after manufacturing and/or customized to perform specific tasks, such as signal processing, cryptography, and machine learning; or (v) a digital signal processor (DSP) designed to perform mathematical operations on signals such as audio, video, and radio waves. One of skill in the art will understand that one or more processors of one or more electronic devices may be used in various embodiments described herein.

As described herein, controllers are electronic components that manage and coordinate the operation of other components within an electronic device (e.g., controlling inputs, processing data, and/or generating outputs). Examples of controllers can include (i) microcontrollers, including small, low-power controllers that are commonly used in embedded systems and Internet of Things (IoT) devices; (ii) programmable logic controllers (PLCs) that may be configured to be used in industrial automation systems to control and monitor manufacturing processes; (iii) system-on-a-chip (SoC) controllers that integrate multiple components such as processors, memory, I/O interfaces, and other peripherals into a single chip; and/or (iv) DSPs. As described herein, a graphics module is a component or software module that is designed to handle graphical operations and/or processes and can include a hardware module and/or a software module.

As described herein, memory refers to electronic components in a computer or electronic device that store data and instructions for the processor to access and manipulate. The devices described herein can include volatile and non-volatile memory. Examples of memory can include (i) random access memory (RAM), such as DRAM, SRAM, DDR RAM or other random access solid state memory devices, configured to store data and instructions temporarily; (ii) read-only memory (ROM) configured to store data and instructions permanently (e.g., one or more portions of system firmware and/or boot loaders); (iii) flash memory, magnetic disk storage devices, optical disk storage devices, other non-volatile solid state storage devices, which can be configured to store data in electronic devices (e.g., universal serial bus (USB) drives, memory cards, and/or solid-state drives (SSDs)); and (iv) cache memory configured to temporarily store frequently accessed data and instructions. Memory, as described herein, can include structured data (e.g., SQL databases, MongoDB databases, GraphQL data, or JSON data). Other examples of memory can include (i) profile data, including user account data, user settings, and/or other user data stored by the user; (ii) sensor data detected and/or otherwise obtained by one or more sensors; (iii) media content data including stored image data, audio data, documents, and the like; (iv) application data, which can include data collected and/or otherwise obtained and stored during use of an application; and/or (v) any other types of data described herein.

As described herein, a power system of an electronic device is configured to convert incoming electrical power into a form that can be used to operate the device. A power system can include various components, including (i) a power source, which can be an alternating current (AC) adapter or a direct current (DC) adapter power supply; (ii) a charger input that can be configured to use a wired and/or wireless connection (which may be part of a peripheral interface, such as a USB, micro-USB interface, near-field magnetic coupling, magnetic inductive and magnetic resonance charging, and/or radio frequency charging); (iii) a power-management integrated circuit, configured to distribute power to various components of the device and ensure that the device operates within safe limits (e.g., regulating voltage, controlling current flow, and/or managing heat dissipation); and/or (iv) a battery configured to store power to provide usable power to components of one or more electronic devices.

As described herein, peripheral interfaces are electronic components (e.g., of electronic devices) that allow electronic devices to communicate with other devices or peripherals and can provide a means for input and output of data and signals. Examples of peripheral interfaces can include (i) USB and/or micro-USB interfaces configured for connecting devices to an electronic device; (ii) Bluetooth interfaces configured to allow devices to communicate with each other, including Bluetooth low energy (BLE); (iii) near-field communication (NFC) interfaces configured to be short-range wireless interfaces for operations such as access control; (iv) pogo pins, which may be small, spring-loaded pins configured to provide a charging interface; (v) wireless charging interfaces; (vi) global-positioning system (GPS) interfaces; (vii) Wi-Fi interfaces for providing a connection between a device and a wireless network; and (viii) sensor interfaces.

As described herein, sensors are electronic components (e.g., in and/or otherwise in electronic communication with electronic devices, such as wearable devices) configured to detect physical and environmental changes and generate electrical signals. Examples of sensors can include (i) imaging sensors for collecting imaging data (e.g., including one or more cameras disposed on a respective electronic device, such as a simultaneous localization and mapping (SLAM) camera); (ii) biopotential-signal sensors (used interchangeably with neuromuscular-signal sensors); (iii) IMUs for detecting, for example, angular rate, force, magnetic field, and/or changes in acceleration; (iv) heart rate sensors for measuring a user's heart rate; (v) peripheral oxygen saturation (SpO₂) sensors for measuring blood oxygen saturation and/or other biometric data of a user; (vi) capacitive sensors for detecting changes in potential at a portion of a user's body (e.g., a sensor-skin interface) and/or the proximity of other devices or objects; (vii) sensors for detecting some inputs (e.g., capacitive and force sensors); and (viii) light sensors (e.g., ToF sensors, infrared light sensors, or visible light sensors), and/or sensors for sensing data from the user or the user's environment. As described herein biopotential-signal-sensing components are devices used to measure electrical activity within the body (e.g., biopotential-signal sensors). Some types of biopotential-signal sensors include (i) electroencephalography (EEG) sensors configured to measure electrical activity in the brain to diagnose neurological disorders; (ii) electrocardiography (ECG or EKG) sensors configured to measure electrical activity of the heart to diagnose heart problems; (iii) EMG sensors configured to measure the electrical activity of muscles and diagnose neuromuscular disorders; (iv) electrooculography (EOG) sensors configured to measure the electrical activity of eye muscles to detect eye movement and diagnose eye disorders.

As described herein, an application stored in memory of an electronic device (e.g., software) includes instructions stored in the memory. Examples of such applications include (i) games; (ii) word processors; (iii) messaging applications; (iv) media-streaming applications; (v) financial applications; (vi) calendars; (vii) clocks; (viii) web browsers; (ix) social media applications; (x) camera applications; (xi) web-based applications; (xii) health applications; (xiii) AR and MR applications; and/or (xiv) any other applications that can be stored in memory. The applications can operate in conjunction with data and/or one or more components of a device or communicatively coupled devices to perform one or more operations and/or functions.

As described herein, communication interface modules can include hardware and/or software capable of data communications using any of a variety of custom or standard wireless protocols (e.g., IEEE 802.15.4, Wi-Fi, ZigBee, 6LoWPAN, Thread, Z-Wave, Bluetooth Smart, ISA100.11a, WirelessHART, or MiWi), custom or standard wired protocols (e.g., Ethernet or HomePlug), and/or any other suitable communication protocol, including communication protocols not yet developed as of the filing date of this document. A communication interface is a mechanism that enables different systems or devices to exchange information and data with each other, including hardware, software, or a combination of both hardware and software. For example, a communication interface can refer to a physical connector and/or port on a device that enables communication with other devices (e.g., USB, Ethernet, HDMI, or Bluetooth). A communication interface can refer to a software layer that enables different software programs to communicate with each other (e.g., APIs and protocols such as HTTP and TCP/IP).

As described herein, a graphics module is a component or software module that is designed to handle graphical operations and/or processes and can include a hardware module and/or a software module.

As described herein, non-transitory computer-readable storage media are physical devices or storage medium that can be used to store electronic data in a non-transitory form (e.g., such that the data is stored permanently until it is intentionally deleted and/or modified).

### Examples of Tensor Cache Compression

Machine learning (ML) models, such as artificial neural networks, often use interconnected nodes that process inputs and pass outputs to other nodes. The nodes are often aggregated into layers such that the layers may be processed, producing intermediate outputs. In some implementations, these intermediate outputs may correspond to tensors (e.g., a multilinear relationship between objects, such as vectors, scalars, other tensors, etc., relating to a vector space, and may often be represented as vectors and/or matrixes).

Certain ML models may use specific tensors frequently such that rather than recalculating the tensor, the tensor may be stored in a tensor cache, which given a size of the tensor, may be stored in a memory (e.g., external to a processor). Due to memory bandwidth limitations, accessing the tensor cache may limit ML execution performance such that ML execution may be memory bound.

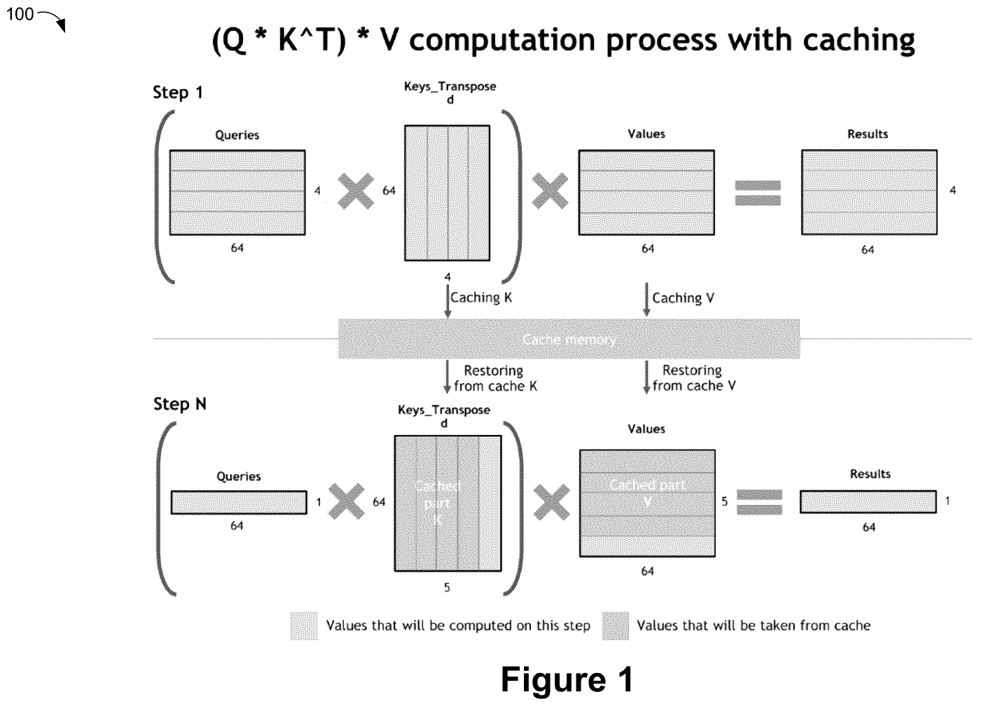

FIG. 1 illustrates a diagram 100 of a tensor cache for a large language model (LLM). A natural language input query may be converted into tokens (e.g., an atomic part processed by an LLM, generally corresponding to a word) and the LLM may autoregressively generate subsequent tokens based on a stopping condition, such as each subsequent token being generated from prior tokens. Accordingly, each sequential output token may rely on previous iterations' output states. For example, in FIG. 1, each iteration uses key tensor (K) and a value tensor (V). Although the initial iteration (Step 1), may have a larger query (e.g., corresponding to the input query) tensor (Q), each subsequent iteration (Step N) uses K and V that builds on the immediately prior iterations' K and V. Rather than rebuilding K and V for each iteration, a tensor cache (e.g., a KV cache) may hold a current K and V, to be retrieved and updated for the next iteration. Due to the size of K and V, the KV cache may be stored on a memory such that accessing the KV cache may limit performance (e.g., memory bound as described above).

The present disclosure is directed to an activation compression scheme for an accelerator, which in some examples allows more efficient storage and retrieval of a tensor cache content such as the KV cache. As the KV cache is an essential component of LLMs, KV cache performance may be an important benchmark for accelerator performance. However, for most of its execution time, LLMs may be bound by the memory bandwidth. More specifically, during the decode phase, all the parameters and KV cache content should be read to compute just the next token. With no batching on-device, fetching parameters may require HW-algorithm optimization. An additional optimization may be needed for accessing the KV-cache, also known as the context.

Optimizing KV cache size may be desirable in certain scenarios. For example, if one LLM is shared between multiple applications, the LLM may have one context per application such that cache compression may be important. In some implementations, the KV cache content may store values in a certain precision (e.g., 16 b) to alleviate the quantization error induced by weight quantization. Further, in other scenarios, batching may be performed on an edge-device thereby increasing KV cache size.

The present disclosure provides hardware architectures and configurations for compressing tensors (e.g., K and V tensors or KV tensors), including reference to pseudo-code for the LLM core building block and the transformer block. The compression scheme described herein may be based on asymmetric block quantization, although other schemes may be used. As will be described herein, example architectures for a direct memory access (DMA) device may include compression and decompression blocks, which may also be used in conjunction with compiler and instruction set architecture (ISA) modifications.

In some examples, LLMs may include cascading multiple transformer blocks. In the core of this block, there is a sub-blocked that receives a single or multiple tokens and applies cross attention between the received tokens and previously generated tokens which are cached (see, FIG. 1). The cached tokens are called KV cache or context, as described above. The cross-attention process includes three linear projections of input token tensors resulting in Q, V, K tensors. The generated K, V tensors are attached to the end of the KV cache, which piles up the most recent K and V tensor values.

In many LLM execution schemes, for an auto-regressive decode phase, one token per input is used, which may require a very low arithmetic intensity. Thus, the main power/performance bottleneck of LLMs may be fetching weights as well as the KV cache entries. As a result, increasing the effective bandwidth may translate to improved performance and power efficiency, linearly. Compressing weights may include quantization to as few bits as possible. However, to avoid large quantization errors from compressing weights, the activation tensors (e.g., K and V tensors) may be finely quantized. Although using 16 b activation (e.g., 16 b values for the activation tensors) may mitigate quantization errors from weight compression, such a scheme may require large KV tensors and accordingly a large KV cache. In the examples described herein, the compression schemes may reduce a 16 b activation to 8 b or lower.

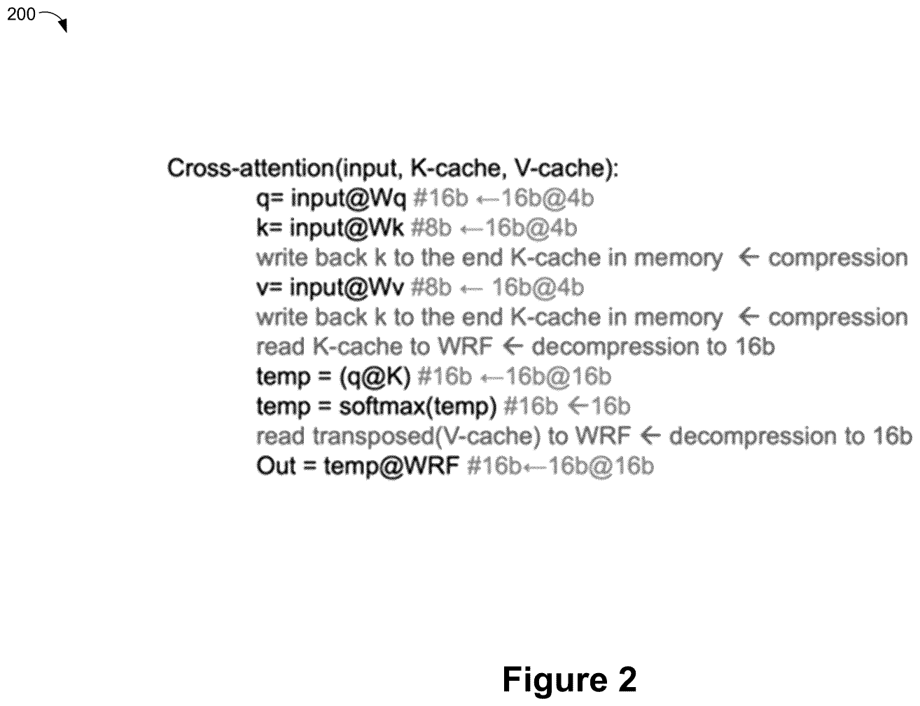

Example pseudo-code 200 for cross-attention is shown in FIG. 2. The pseudo-code 200 shows compression/decompression operations. As shown in pseudo-code 200, the projected k and v of the current input token may be attached to the end of KV cache. As the KV cache resides outside an accelerator in a compressed form, the KV cache may be fetched via weight DMA as K-cache and V-cache are later used as weight in matrix multiplication (e.g., MatMul designated by “@”) operations.

In some examples, the K and V tensors may have different reduction dimensions. For both K and V that have (batch, seq, h, emb) shape, the cross-attention may be parallelized into h heads, where each head works with (batch, seq, emb) K and V sub-tensor. For K and V, the reduction dimensions may be emb and seq, respectively. The compression schemes described herein may use per-block compression such that block of K and V tensors may be compressed independently, although other configurations may be used in other examples. Further, although the compression schemes described herein are configured for LLMs and KV cache compression, in other examples the compression schemes may be used for activation compression in general (e.g., other tensor caches).

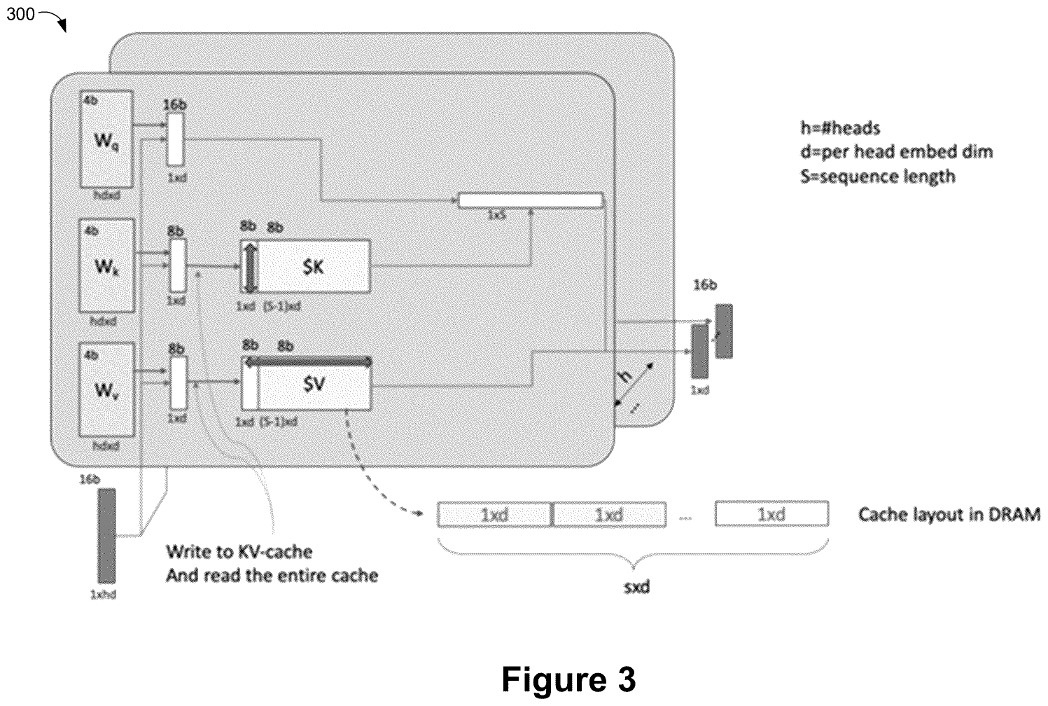

FIG. 3 illustrates an attention block 300 used in an LLM. FIG. 3 may correspond to a decode phase. For example, an int16 vector of size h*d may be multiplied with 4 b weights (e.g., W_{q}, Wₖ, Wᵥ) to generate 16 b and 8 b results. The k and v vectors may be concatenated to the KV cache, and the entire KV cache may be used in the next two matrix multiplication operations. The operation may occur for each head independently and generate the result by a concat operation. The KV cache content may be stored in token-major format per head per layer.

In some examples, rather than having explicit compression and decompression operations (see, e.g., FIG. 2), compression and compression may be added into a quantization configuration. Further, in some examples, a special flag may be added in the quantization configuration to indicate the compression scheme used, as will be described further below. A compiler may take this information and transform them to compression and decompression nodes in a corresponding graph module.

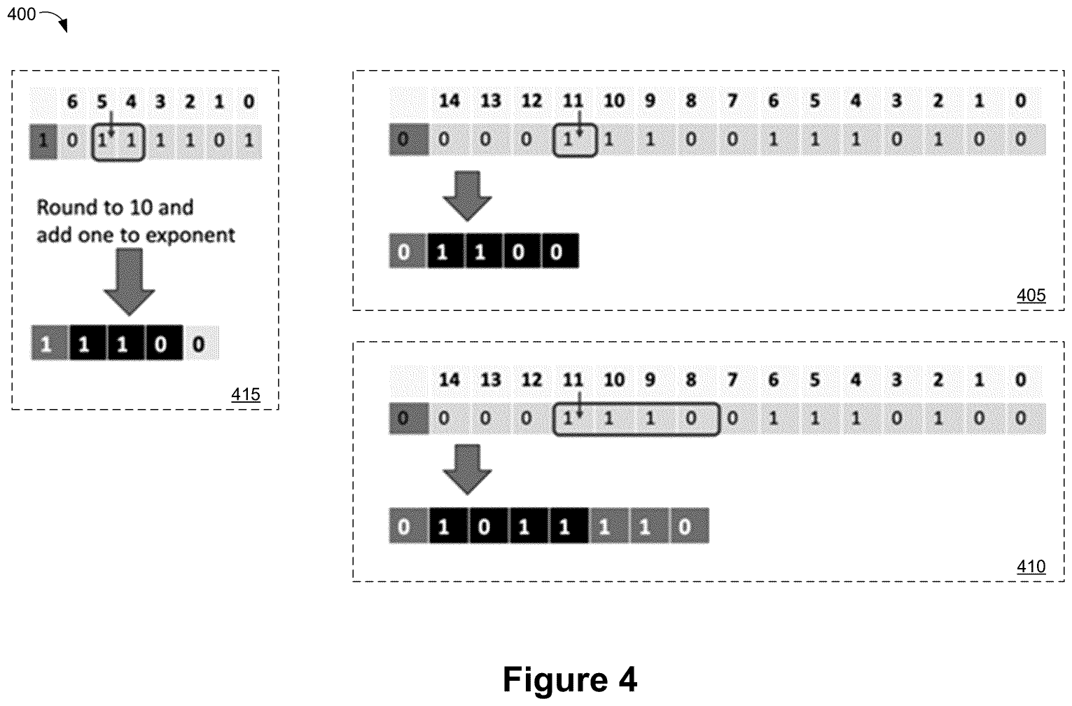

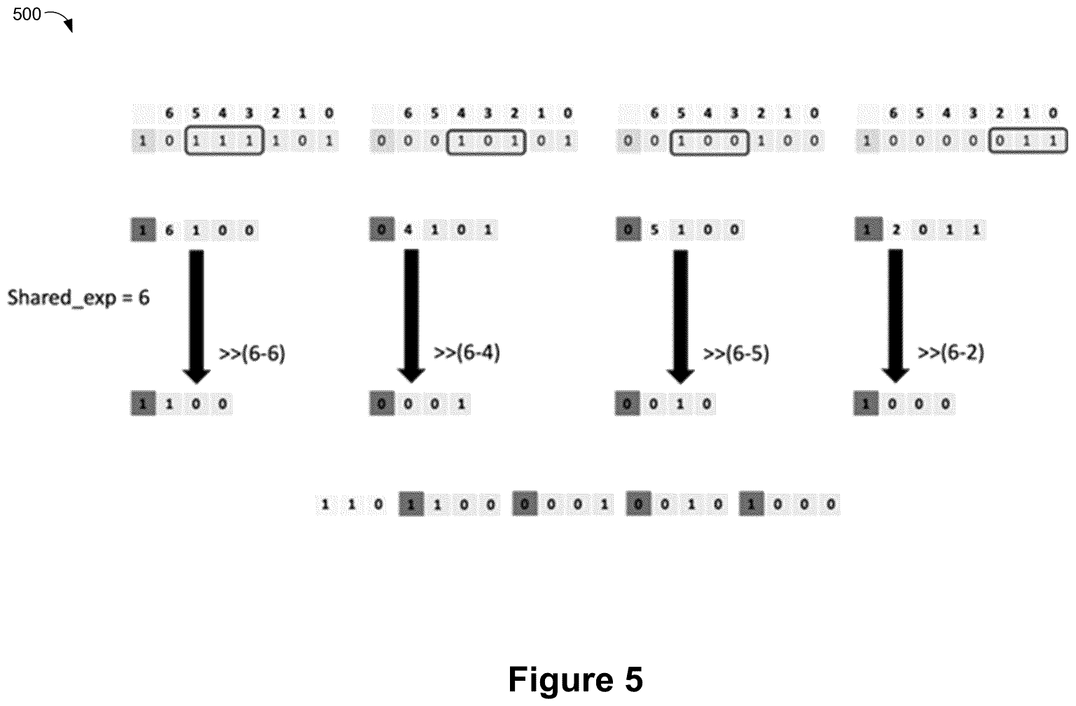

FIGS. 4 and 5 illustrate example compression schemes (e.g., non-uniform compression) that may be applied to INT values of uniformly quantized tensors, although in other examples, compressions schemes may be applied to other number formats.

FIG. 4 illustrates a private exponent scheme 400. In some examples, non-uniform compression allows storing a floating point-like number for an input integer. Generally, the private compression schemes may receive an input and return a sign, position of the most significant non-zero bit, and the bit right after most significant non-zero bits. For example, an original bit value of size n may be compressed to a compressed bit value of size m<n. In some examples, a sign bit of the original bit value may be preserved. The original mantissa bits may be compressed into an exponent component that may represent a most significant non-zero bit and/or one or more following bits (e.g., either directly or via rounding and/or adding). In some examples, the compressed value may also include a mantissa component that may directly or indirectly correspond to the most significant non-zero bit and/or one or more following bits.

In the case of int16→5 b (illustrated on the top right square 405), the scheme may maintain the sign bit (1 b) as well as position of the most significant non-zero bit as exponent bits (4 b) with one implicit hidden bit (e.g., “1”). For example, the most significant non-zero bit may be the hidden bit as this scheme may only store the sign and the position of the most significant bit in the remaining 4 b. In some examples, the position of the most significant non-zero bit may be based on applying a rounding scheme (e.g., adding “1” to a bit following the MSB, such as a bit outside of bits represented by the mantissa, which may change which bit is the most significant non-zero bit).

For int16→8 b (illustrated on the bottom right of square 410), this scheme may store the sign (1 b), position of the most significant non-zero bit as exponent bits (4 b), and the three bits right after the most significant non-zero bit as mantissa bits (3 b). As illustrated in FIG. 4, for 16 b compression, 4 bits may be used for the exponent (e.g., 4 bits used to index any of the original 16 bit positions).

For int8→5 b (illustrated on the top left square 415), the scheme may keep the sign bit (1 b), exponent bits (3 b corresponding to the original 8 bit positions) and one mantissa bit.

FIG. 4 illustrates particular examples as applied to 16 and/or 8 bit values. In other examples, private exponent scheme 400 may be applied to other sizes of bit values that may be less than 8 bits, between 8 and 16 bits, or greater than 16 bits. Further, the compressed bit value size may correspond to any number of bits less than the original number of bits. In addition, bit value components (e.g., sign bit, exponent bits, mantissa bits, etc.) may be of different bit sizes. Also, an order of the bit value components may also vary as needed. As described herein, a number of bits for indexing (e.g., exponent bits) may correspond to a number of bit indexes of the original value, which may correspond to a maximum number of bit indexes although in other examples may correspond to a truncated or reduced number. In some examples, a number of mantissa bits may correspond to a number of available bits (e.g., after accounting for sign and/or exponent bits), although in other examples, any appropriate number of mantissa bits may be used. For examples, certain bits may also be reserved for other information. Moreover, as described herein, in some examples, an MSB value may be rounded, although in other examples such rounding may not be used.

FIG. 5 illustrates a shared exponent scheme 500. In shared exponent scheme 500, a block of numbers may share the same exponent (e.g., position of most significant non-zero bit). The shared exponent may correspond to the maximum exponent of the input number when compressed with the private exponent scheme. In FIG. 5, the block size may be 4 numbers although in other examples other block sizes may be used. In some examples, this scheme may not track which numbers have the maximum exponent such that there may be no implicit hidden bits. For example, an original bit value of size n may be compressed to a compressed bit value of size m<n. In some examples, a sign bit of the original bit value may be preserved. A block of original bit values (e.g., more than one original bit value) may be grouped as a block sharing an exponent. The sign bits of the original bit values may be preserved. The shared exponent may be determined from the original bit values, such as the largest bit index of the most significant non-zero bits of each of the original bit values. Mantissa components for the compressed bit values may be derived from the shared exponent, such as shifting bits (e.g., original bit values having most significant non-zero bit of a smaller bit index than the shared exponent would have their mantissa value shifted to match the shared exponent), rounding, adding, as needed. Moreover, in some examples a subset of the original bit value may be compressed.

FIG. 5 illustrates the shared exponent case for int8→5 b. In one example, the shared exponent (int8→5 b) may be determined by: (1) finding a sign position of a most significant non-zero bit and three bits starting from most significant non-zero bit as mantissa bits; (2) if the three bits are 111, rounding up the exponent (e.g., as illustrated in the left number in FIG. 5, promoting the exponent value to 6 rather than 5 as the original most significant non-zero bit); (3) making the max exponent (e.g., of the block of numbers) the shared exponent; and (4) shifting the mantissa bit based on the distance from their corresponding exponents and the shared exponent. By sharing the exponent, the mantissa may include additional bits as compared to the private exponent schemes described above. For example, 3 b of mantissa may be used such that a total number of bits used for the block of numbers is less than or equal to a number of bits for each compressed number.

In other examples, other variations of shared exponent scheme 500 may be used, such as different sizes of original bit values (e.g., sizes other than 8 or 16 bits), with any compressed bit size less than the original bit size. For example, a number of values (e.g., block size) may correspond to a number of values able to be compressed into a particular bit size (e.g., word size or other appropriate size). As described above, a number of bits for the bit value components (e.g., sign bit, exponent bits, mantissa bits, etc.) may vary, as well as the order may vary. In addition, although the examples herein describe a fixed block size, in other examples, other block sizes may be used, and may also vary. For example, one or more bits may be reserved for indicating the block size. Moreover, although the examples herein describe using the max exponent as the shared exponent, in other examples, the shared exponent may correspond to a different exponent, and rounding may or may not be used as needed for the mantissa bits. Further, in some examples, shared exponent scheme 500 may be applied to values of different bit sizes. Moreover, in some examples a subset of the original bit value may be compressed.

In some examples, a compression engine (e.g., compressor) and a decompression engine (e.g., decompressor) may be integrated with appropriate DMAs, such as a cluster DMA and a weight DMA.

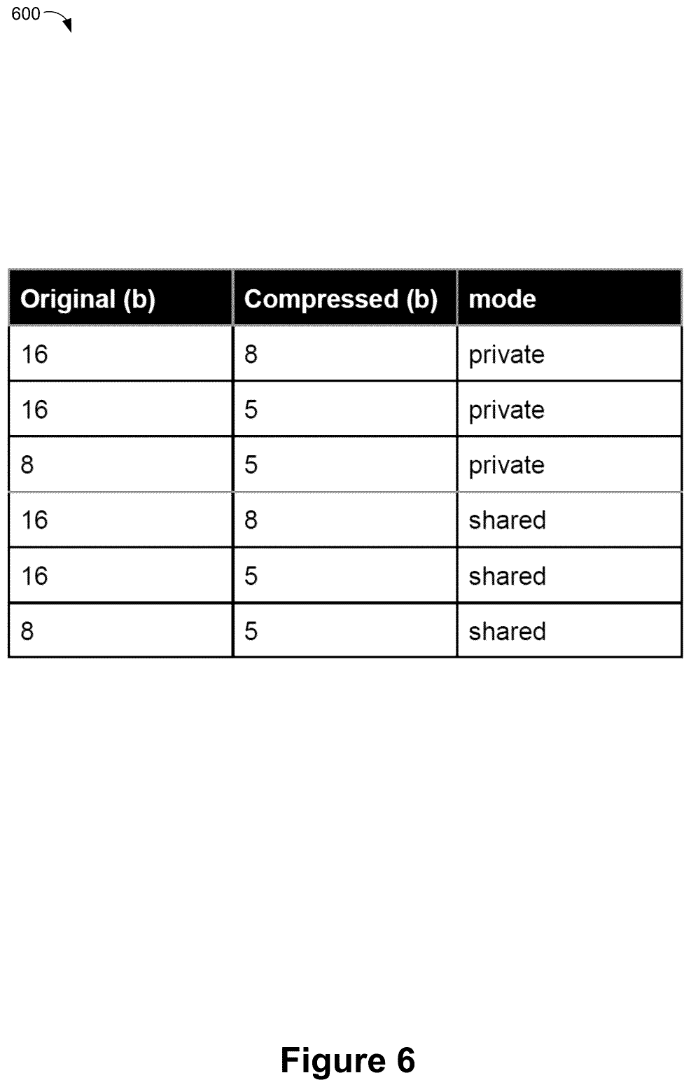

FIG. 6 illustrates a table 600 enumerating compression schemes described herein that may be supported by the compressor/decompressor, although in other examples other additional or fewer schemes may be supported. FIG. 6 illustrates bit precisions excluding metadata overhead, although illustrates a number of bits per element including overhead.

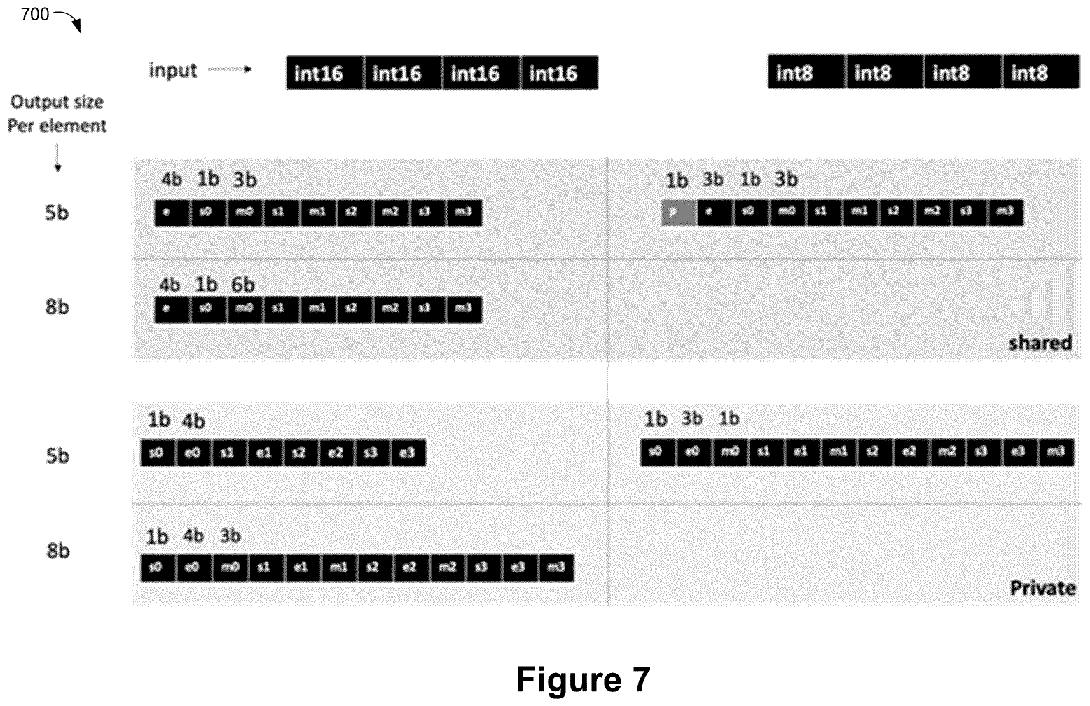

FIG. 7 illustrates a diagram 700 of inputs (e.g. bit precisions) and outputs of the compression schemes described herein. In other examples, other bit sizes may be used as described herein.

Although the examples herein are described with respect to examples relating to LLMs, such as a KV cache, in other examples, the systems and methods provided herein may be applied to other machine learning schemes, such as other tensor caches, and in yet other examples, may be applied to other scenarios involving dynamically generated data used for intermediary operations. For example, in scenarios in which data is dynamically determined during execution or is otherwise not pre-generated, but the dynamically determined data may be reused and/or incrementally updated and reused for subsequent operations, the systems and methods provided herein may advantageously improve processing performance. In addition, in some examples, the compression schemes described herein may be selectively applied, for example applied to portions of the dynamically generated data (e.g., based on bit size, desired accuracy, etc.).

Moreover, although the examples described herein may apply a common compression scheme for operations, in other examples different compression schemes and/or variations thereof may be used for one or more operations, subsequent operations, and/or modified during operations. For instance, by using compression hardware, the compression hardware may recognize the appropriate compression scheme and apply the same. In some examples, reading and/or writing data may include using an instruction that may have a flag or other identifier (e.g., defined in a corresponding ISA) to indicate which compression scheme is to be used. In some examples, this compression hardware may be implemented with (e.g., integrated with) and/or otherwise interface with a memory controller, DMA engine, etc. In addition, the compression schemes described herein may correspond to a quantized floating point format that may include a mantissa portion (corresponding to a non-zero MSB of an integer) and an exponent portion.

Features from any of the embodiments described herein may be used in combination with one another in accordance with the general principles described herein. These and other embodiments, features, and advantages will be more fully understood upon reading the following detailed description in conjunction with the accompanying drawings and claims.

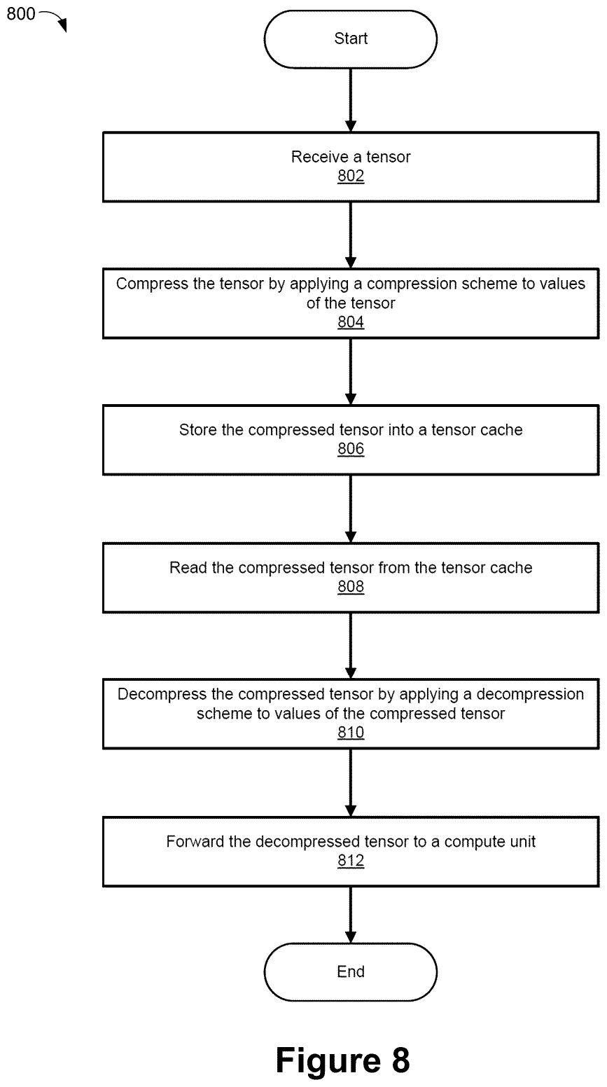

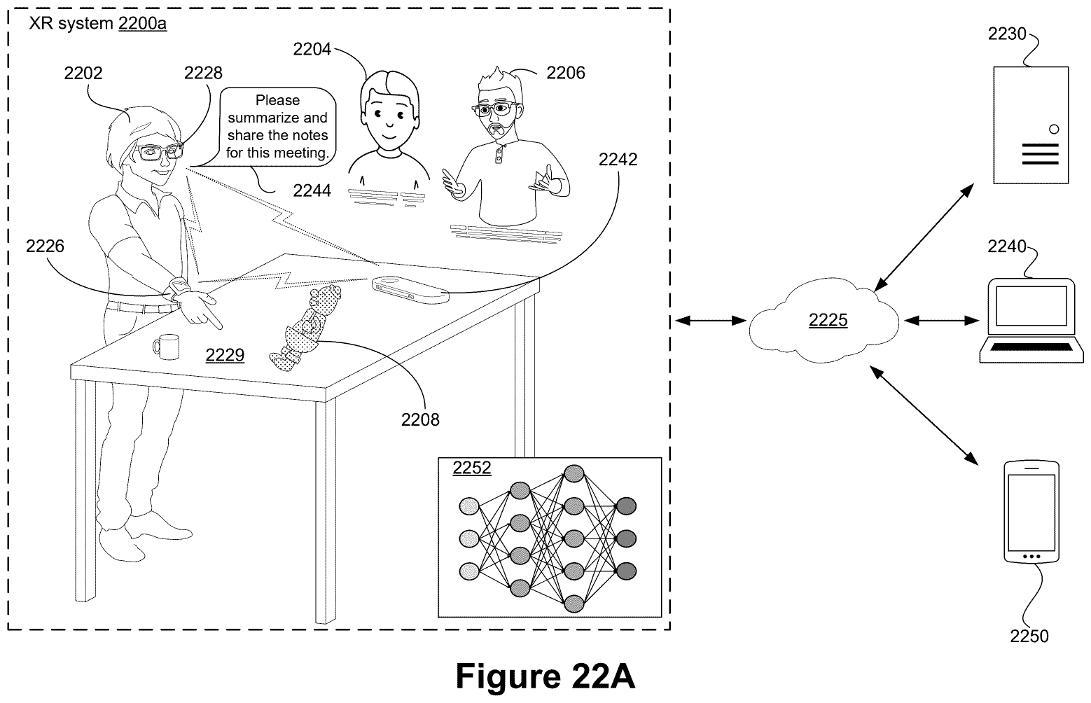

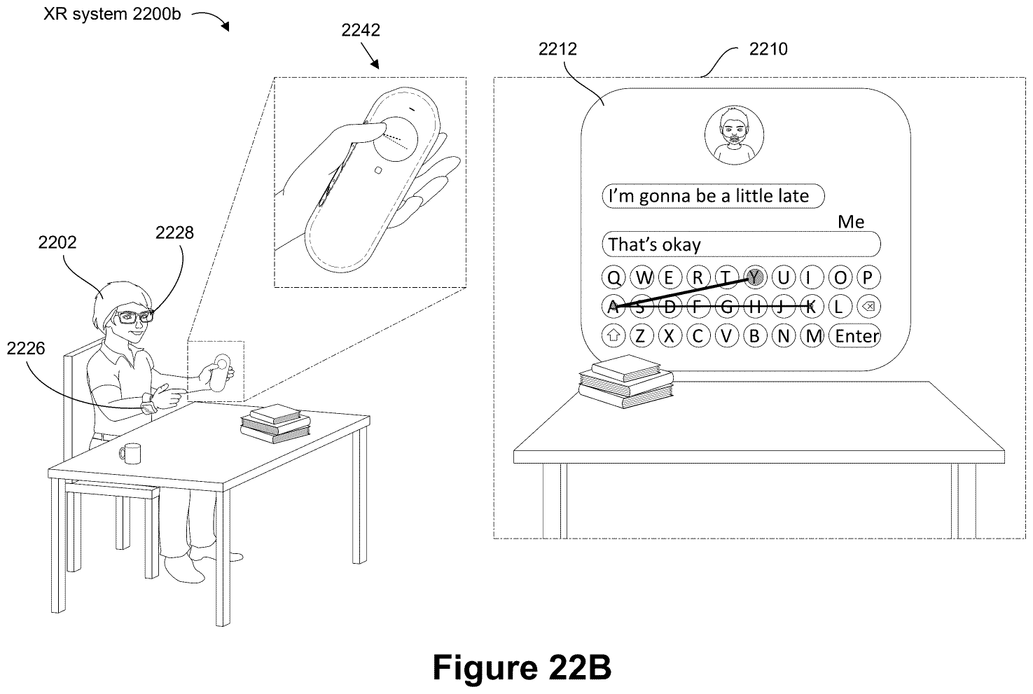

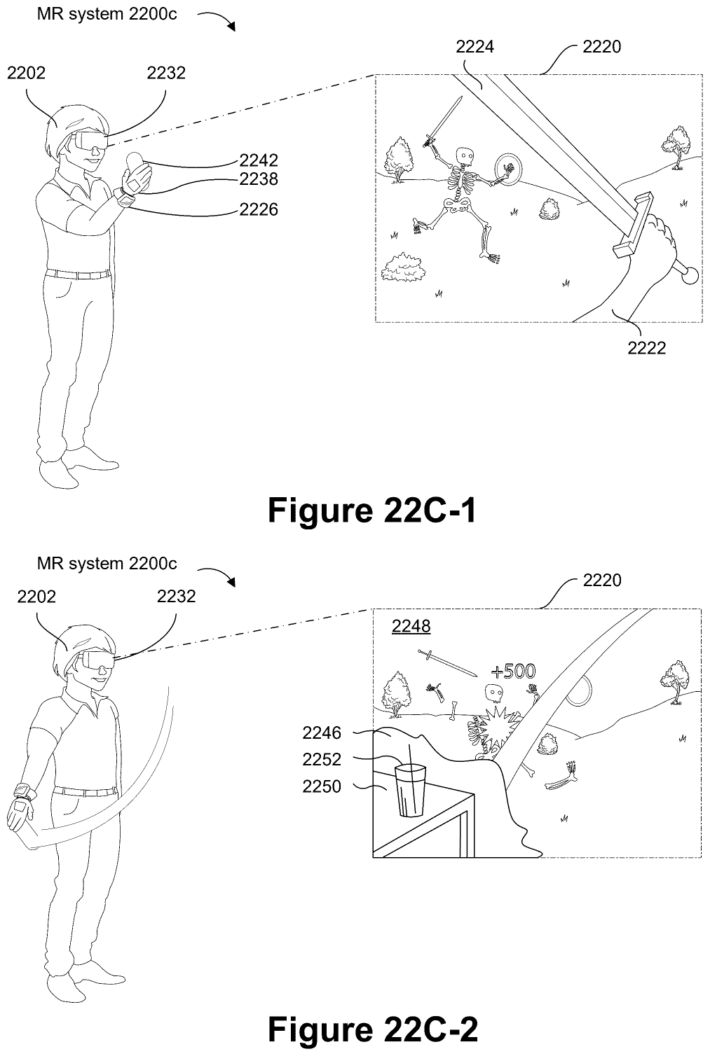

FIG. 8 is a flow diagram of an exemplary computer-implemented method 800 for tensor cache compression/decompression. Operations (e.g., steps) of the method 800 can be performed by one or more processors (e.g., central processing unit and/or MCU) of a system (e.g., an XR system described in below in reference to FIGS. 22A-22C-2). At least some of the operations shown in FIG. 8 correspond to instructions stored in a computer memory or computer-readable storage medium (e.g., storage, RAM, and/or memory). Operations of the method 800 can be performed by a single device alone or in conjunction with one or more processors and/or hardware components of another communicatively coupled device (e.g., one or more devices of an XR system described below in reference to FIGS. 22A-22C-2) and/or instructions stored in memory or computer-readable medium of the other device communicatively coupled to the system. The steps shown in FIG. 8 may be performed by any suitable computer-executable code and/or computing system, including the system(s) described herein. In one example, each of the steps shown in FIG. 8 may represent an algorithm whose structure includes and/or is represented by multiple sub-steps, examples of which will be provided in greater detail below. In some embodiments, the various operations of the methods described herein are interchangeable and/or optional, and respective operations of the methods are performed by any of the aforementioned devices, systems, or combination of devices and/or systems. For convenience, the method operations will be described below as being performed by particular component or device, but should not be construed as limiting the performance of the operation to the particular device in all embodiments.
(A1) As illustrated in FIG. 8, at step 802 one or more of the systems described herein may receive a tensor, although in other examples, the tensor may correspond to any dynamically generated data (e.g., data not previously generated such as before program execution). At step 804 one or more of the systems described herein may compress the tensor by applying a compression scheme to values of the tensor. At step 806 one or more of the systems described herein may store the compressed tensor into a tensor cache. At step 808 one or more of the systems described herein may read the compressed tensor from the tensor cache. At step 810 one or more of the systems described herein may decompress the compressed tensor by applying a decompression scheme to values of the compressed tensor. At step 812 one or more of the systems described herein may forward the decompressed tensor to a compute unit.
(A2) In some embodiments of A1, the compression scheme is indicated by a compression flag in an instruction for storing the tensor.
(A3) In some embodiments of any one of A1-A2, the compression scheme corresponds to quantizing an integer into a quantized floating-point format having a reduced bit size.
(A4) In some embodiments of A3, the quantized floating-point format retains a sign bit of the integer.
(A5) In some embodiments of any one of A3-A4, the quantized floating-point format includes an exponent portion corresponding to a position of a non-zero most significant bit (MSB) of the integer.
(A6) In some embodiments of A5, the compression scheme includes determining the exponent portion for each integer value.
(A7) In some embodiments of any one of A5-A6, the compression scheme includes determining the exponent portion for a group of integer values.
(A8) In some embodiments of any one of A3-A7, the quantized floating-point format includes a mantissa portion corresponding to a value of a non-zero most significant bit (MSB) of the integer.
(A9) In some embodiments of A8, the mantissa portion includes one or more additional bits after the non-zero MSB.
(A10) In some embodiments of A9, the one or more additional bits are determined based on the reduced bit size.
(A11) In some embodiments of any one of A8-A10, the mantissa portion includes a hidden bit.
(A12) In some embodiments of any one of A3-A11, the compression scheme includes rounding a subset of bits of the integer.
(A13) In some embodiments of any one of A1-A12, a direct memory access (DMA) engine compresses the tensor

### Examples of Spatially Distributed Computation

The present disclosure is generally directed to spatially distributed computing, such as for weight computations for convolution operations. For convolution operations, such as for an LLM or other neural network or machine learning model, activation values (e.g., tensors) and weight values may be computed together, such as in matrix/vector computations. Accelerator hardware may support various precisions (e.g., bit sizes) of values. However, based on desired precisions, such as for weights, accelerators may not have flexible architectures to efficiently support certain operations.

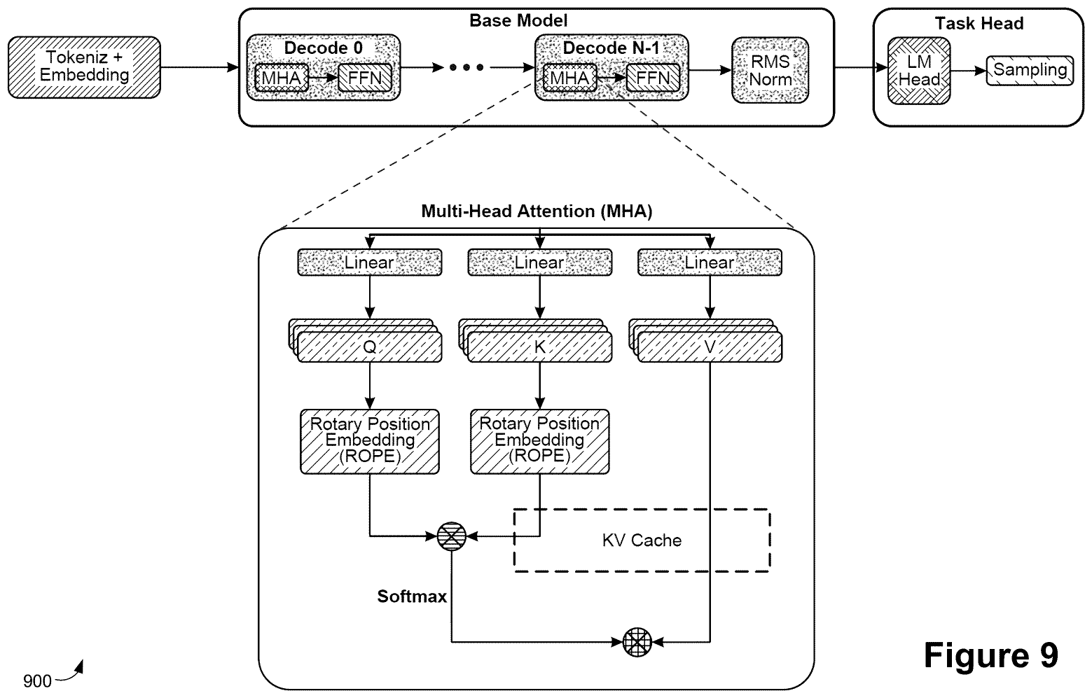

FIG. 9 illustrates an example architecture of an LLM for performing various activation and weight calculations such as linear, point-wise, etc. In other examples, other machine learning models (with appropriate calculations) may be used. In addition, although the non-limiting examples described herein refer to activation and weight values having 16 b or 8 b sizes, the systems and methods described herein may be used for any matrix multiplication architectures (e.g., using values representing activation values, weight values, other tensors, or any other values, and further may be read from any type of memory device and/or memory architecture), including various memory devices/architectures, for any bit precisions/sizes. The examples described herein correspond to a factor of two between bit sizes (e.g., 16 b and 8 b) corresponding to two sets of architectures, splitting into two, etc., although in other examples the systems and methods described herein may be similarly applied for other factors of difference between bit sizes, which similar changes to architecture.

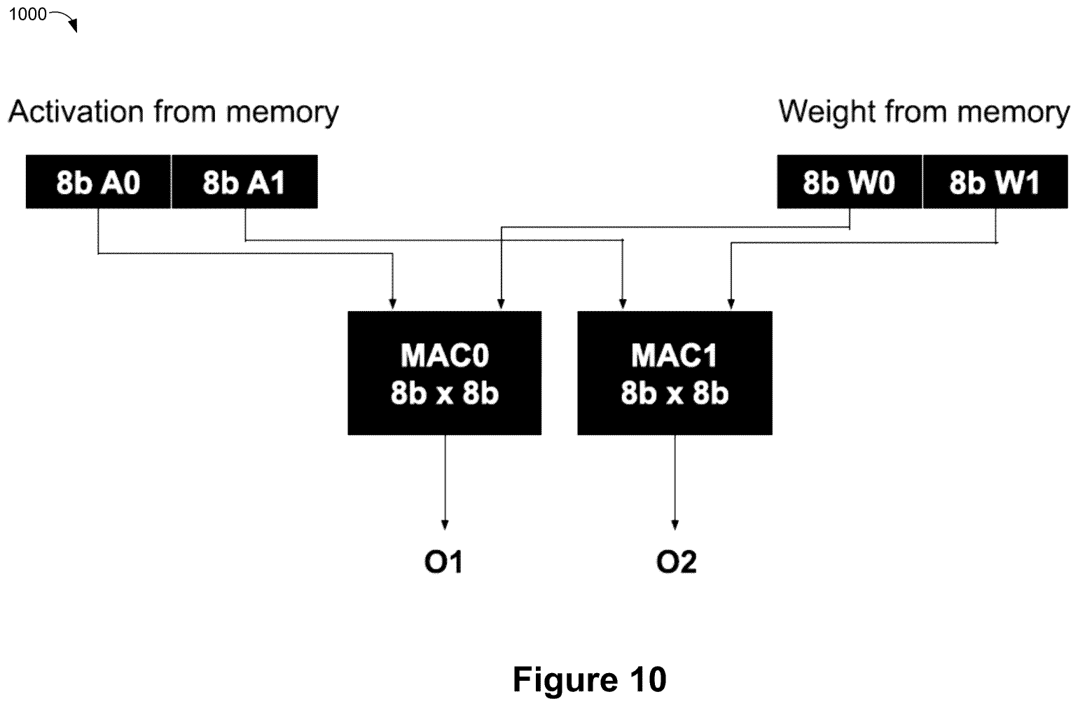

An example architecture may support a given bit size, such as 8 b, such that a multiply-and-accumulate (MAC) unit may perform an operation using two operand values of the bit size. The operands may be sent to MAC units for performing portions of array (e.g., vector/matrix) computations. Each MAC may perform an operation (e.g., multiplication using an activation value with a weight value) along with an accumulation by an accumulator, to produce an output. FIG. 10 illustrates an example architecture in which MACs may operate in pairs (e.g., MAC0 and MAC1). For example, an activation operation may use values from an activation matrix stored in memory as one operand, and values from a weight matrix stored in memory as the other operand.

FIG. 10 illustrates an example in which two 8 b activations, A0 and A1, are input into MAC0 and MAC1, respectively. Similarly, two 8 b weights, W0 and W1, are input into MAC0 and MAC1, respectively. These may generate respective outputs O1 and O2, such that two activations are performed in parallel with this architecture.

Each MAC may be restricted in bit size of operands. However, a larger bit size activation (e.g., 16 b) may be divided.

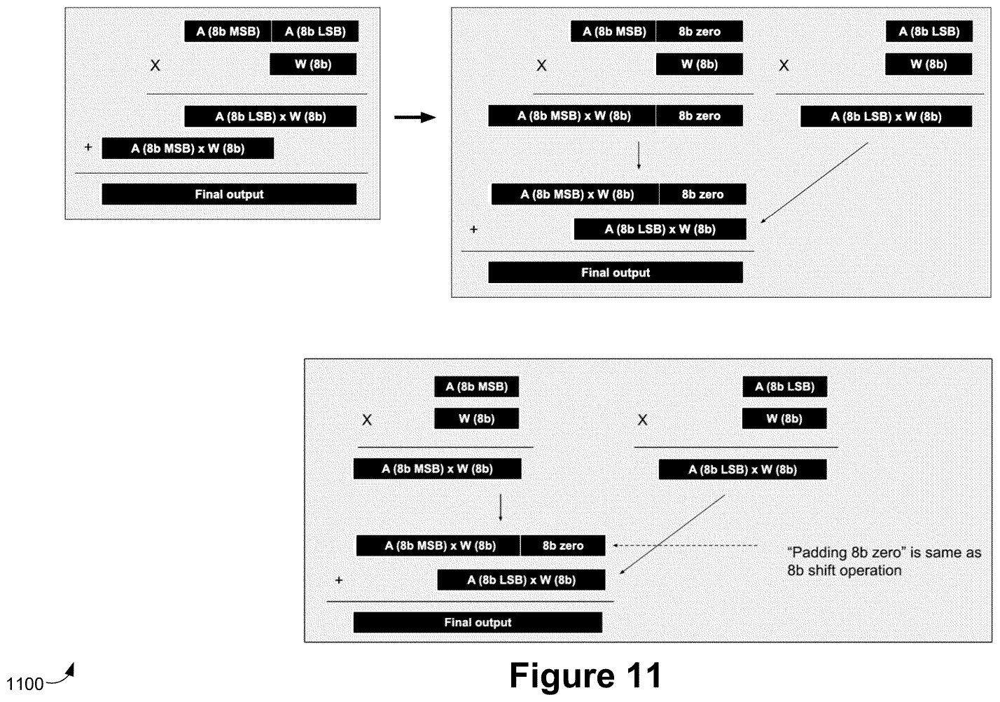

FIG. 11 illustrates similarities in a multiplication operation of a larger number and a multiplication operation of smaller numbers that are then added. More specifically, an original operand may be partitioned into mantissa digits of smaller exponents, and mantissa digits of larger exponents having padded zeros for the smaller exponents. Using binary numbers, a 16 b number may be divided into most significant bits (MSB) and least significant bits (LSB) non-overlapping halves, and the padding of zeroes may be equivalent to a bit shifting operation. This allows splitting a 16 b value into two 8 b values, performing the multiply on the 8 b values to produce intermediate results, and shifting the MSB intermediate result by 8 b and adding these intermediate results to produce the desired result.

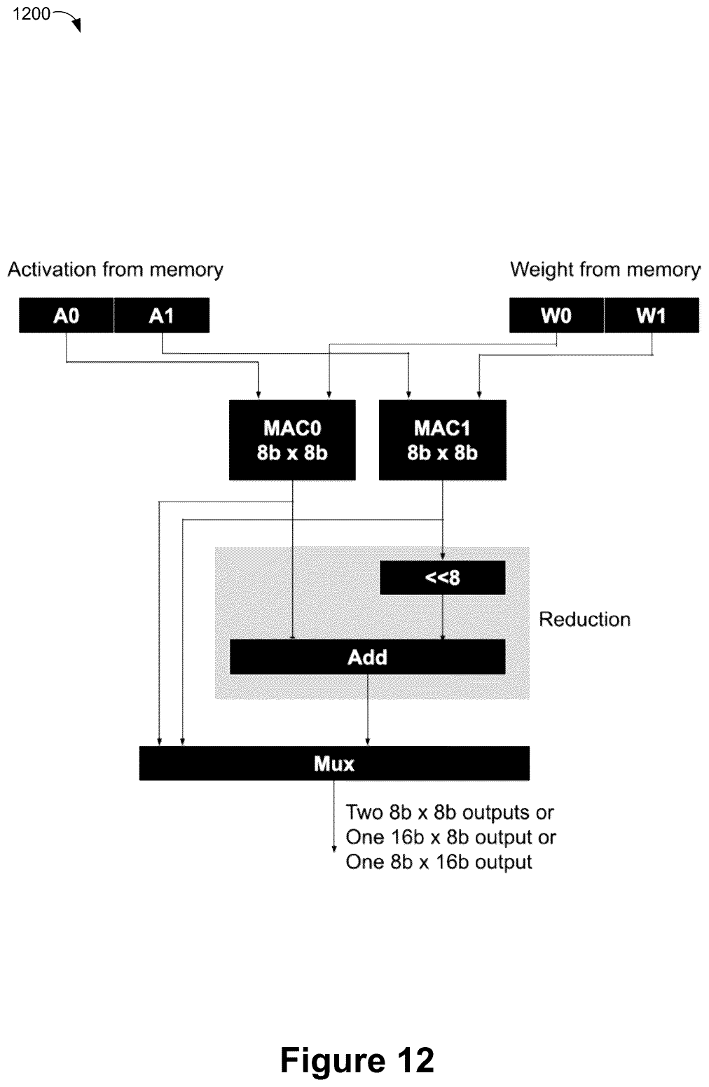

Returning to the MAC pair architecture, FIG. 12 illustrates a MAC pair (similar to FIG. 10) which may support 16 b and 8 b computation. For an 8 b×8 b operation (similar to FIG. 10), MAC0 and MAC1 may receive the corresponding A0, W0 and A1, W1 inputs, and output values accordingly, bypassing the reduction block illustrated. The reduction block may correspond to the adding of intermediate results described above and used for a 16 b operation as will be described further below.

For a 16 b operand, and more specifically, a 16 b (activation)×8 b (weight) operation, the 16 b activation may be divided into an MSB half (e.g., A1 in FIG. 12) and an LSB half (e.g., A0 in FIG. 12). As will be described further below, in a 16 b mode, the reduction block may perform the bit shift operation and add the intermediate results to produce the final result. Accordingly, the multiplexer may output 16 b, which may correspond to two 8 b outputs for two 8 b×8 b operations, or one 16 b output for 16 b mode (e.g., one 16 b operand and one 8 b operand). In some examples, the reduction block may support either original operand (activation or weight) being 16 b, although FIG. 12 illustrates an example for 16 b activation.

For the 16 b activation×8 b weight operation, the same 8 b operand is used for the MSB and LSB operations. Although in some examples, the same 8 b weight value may be stored as W0 and W1 in FIG. 12, this may result in double storing of many weight values and inefficient usage of memory.

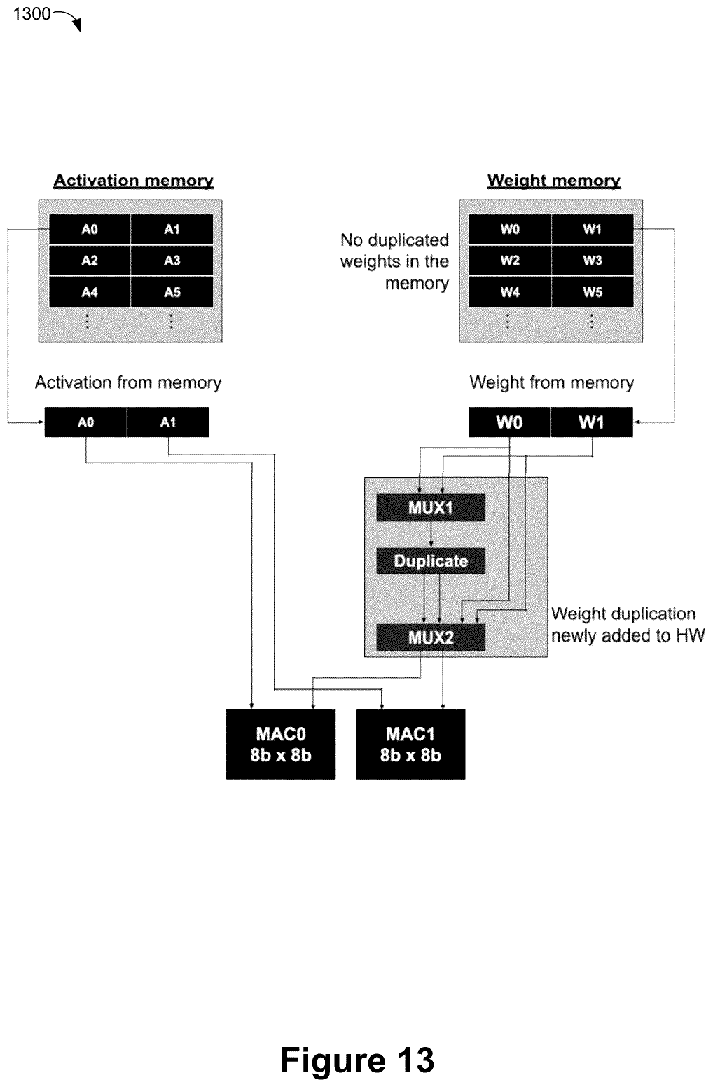

FIG. 13 illustrates an architecture that may duplicate weight values to avoid duplicate storage (e.g., wherein the duplication happens at the memory). In an 8 b activation mode, weight duplication is not needed as each 8 b activation value uses its own corresponding 8 b weight such that MUX2 may send the original W0 and W1 values. In a 16 b activation mode, MUX1 may duplicate W0 to send.

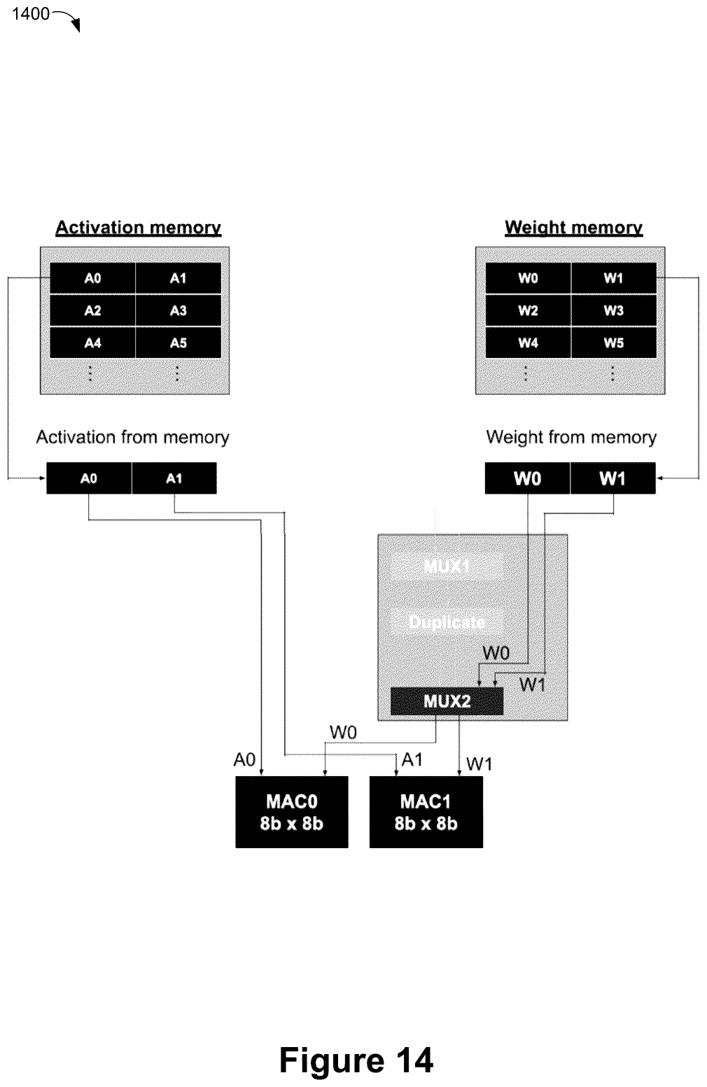

FIG. 14 illustrates the architecture (e.g., FIGS. 12 and 13) in an 8 b mode or 8 b activation×8 b weight operation. The two activation values A0 and A1 are read from memory into MAC0 and MAC1, respectively. The two weight values W0 and W1 are read from memory, and in this 8 b mode MUX1 may be disabled and MUX2 enabled, such that W0 and W1 are read into MAC0 and MAC1, respectively.

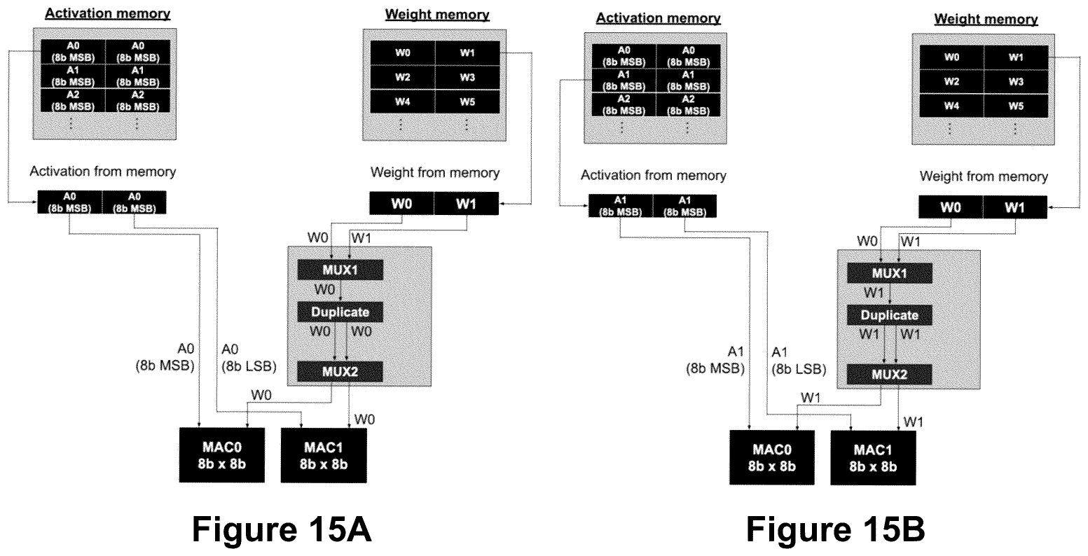

FIGS. 15A and 15B illustrates the architecture (e.g., FIGS. 12 and 13) in a 16 b mode or 16 b activation×8 b weight operation. In FIG. 15A, activation value A0 is read as two 8 b values from memory into MAC0 and MAC1, respectively, which in 16 b mode corresponds to MSB (into MAC0) and LSB (into MAC1) for A0. Weights W0 and W1 may be read from memory. MUX1 may be enabled in 16 b mode to select the corresponding weight (W0), which may be duplicated and sent to MAC0 and MAC1 (the outputs of which may be reduced by a reduction block as described above).

On a next cycle, in FIG. 15B, activation value A1 is read as two 8 b values from memory into MAC0 and MAC1, respectively, which in 16 b mode corresponds to MSB (into MAC0) and LSB (into MAC1) for A1. Weights W0 and W1 may be read from memory again, and/or cached/buffered or otherwise accessed again. MUX1 may be enabled in 16 b mode to select the corresponding weight (W1), which may be duplicated and sent to MAC0 and MAC1 (the outputs of which may be reduced by a reduction block as described above).

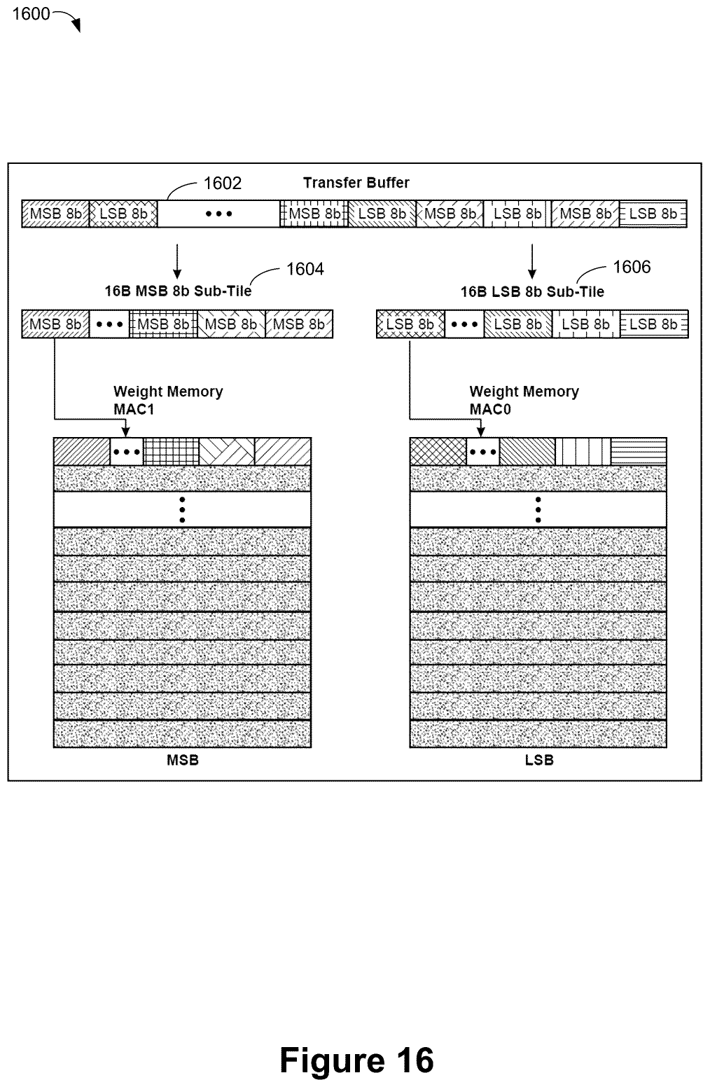

FIG. 16 illustrates an example of transferring weight data from memory storage to a compute unit. Weight data may be densely packed in contiguous blocks 1602, such as 16 b blocks (having an 8 b MSB portion and 8 b LSB portion). FIG. 16 illustrates a transfer buffer 1600 of weight data that may be read from a memory by a direct-memory access (DMA) engine into a weight memory. The DMA engine may split the weight data into two sets, such as two equal-sized sets of 16B split by MSB/LSB (e.g., MSB sub-tile 1604 and LSB sub-tile 1606) for sending to corresponding MACs (e.g., as described above). In some examples, the address for weight memory entries for the two MACs in a set may be the same.

Although these example, describe 16 b and 8 b, in other examples other bit sizes may be used (e.g., 32 b and 16 b, etc.) as well as different number of divisions (e.g., 24 b and 8 b, using three MACs).

In some examples, hardware may be used for different precisions (e.g., bit sizes), although in other examples, may be supported by using spatially/temporally distributed operations. In some examples, the MSB portion may be signed and the LSB portion may be unsigned, although each MAC may have its own sign bit. Further, in some examples, although each MAC is separate, the pair of MACs may be considered as a group (e.g., for computations with corresponding MSB/LSB sub-weights). Further, in some examples, the MACs may perform computations in parallel or nearly in parallel to reduce a delay between every MAC completing outputs.

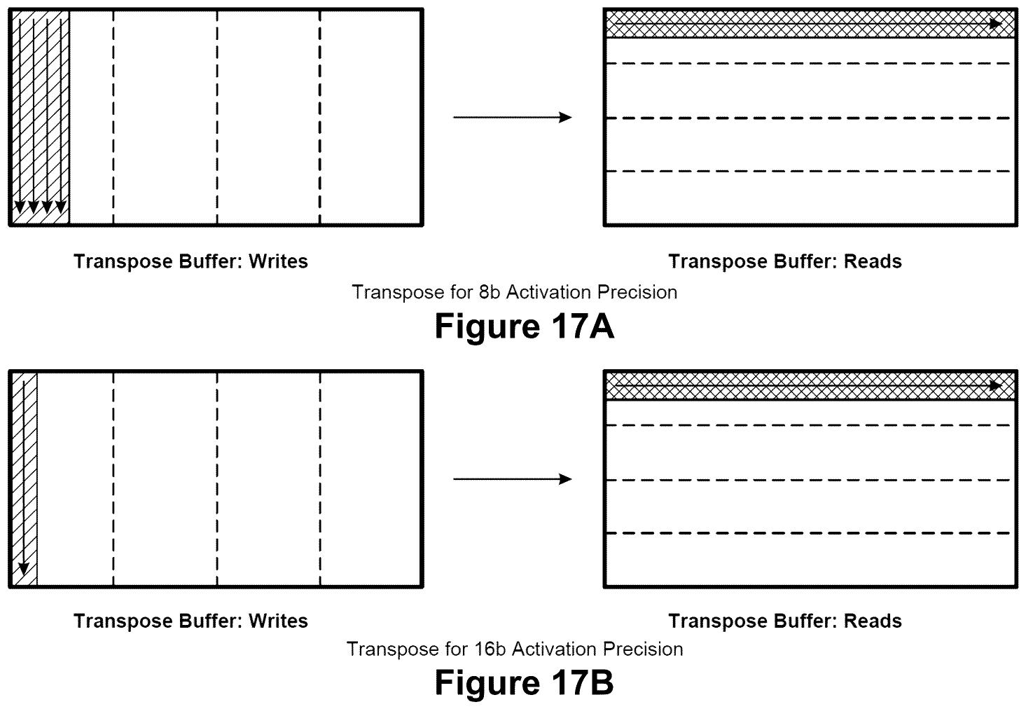

FIGS. 17A and 17B illustrate an example transposing for an activation matrix. FIG. 17A illustrates a transpose for 8 b activation precision, which in some examples may use similar mapping as if weight duplication was present. For sub-weight (e.g., 8 b weight) operation, the operation may be split over two MACs as described herein.

FIG. 17B illustrates a transpose for 16 b activation precision, which in some examples corresponds to a double transpose logic. In some examples, the DMA engine may support splitting and transposing.

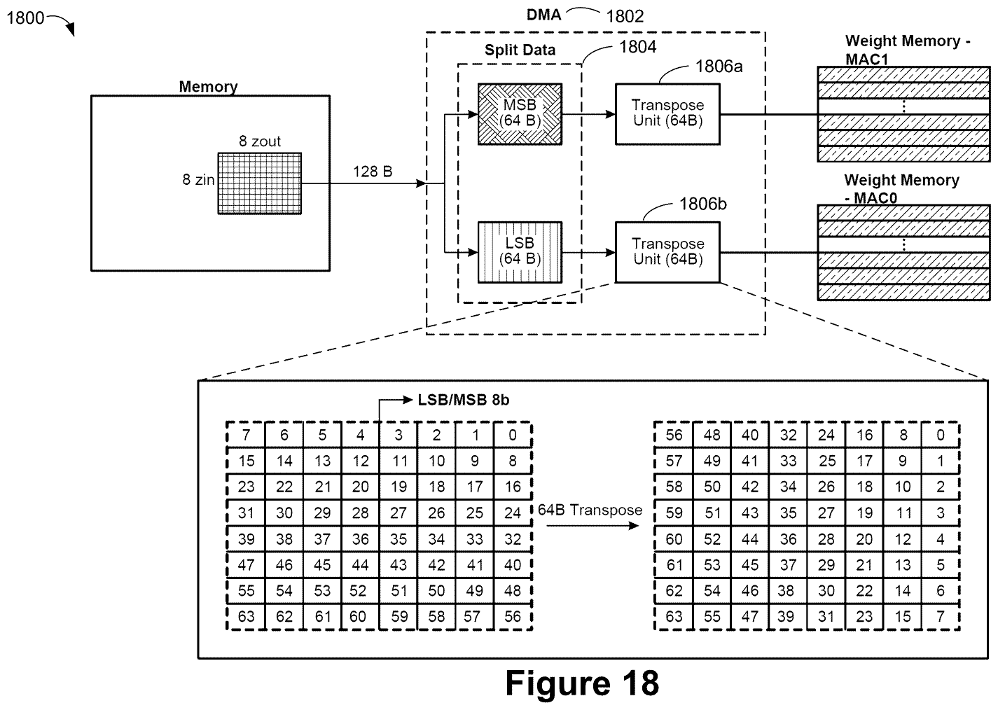

FIG. 18 illustrates another transpose example 1800, for example for weight values, and more specifically for 16 b weight values. In some examples, a reduction block for 16 b weight operations may reside outside of a MAC unit array (e.g., in contrast to the MAC unit arrays in FIGS. 11-15B). Rather than transposing the original 16 b weight matrix, the 16 b weight values may be split 1804, and split data matrixes transposed. For example, DMA engine 1502 may split the data (e.g., based on MSB/LSB), and using a separate transpose unit (e.g., transpose units 1806a and 1806b) for each, transpose the weights as illustrated for writing to weight memories, which may further correspond to MACs (e.g., based on MSB/LSB as described herein). As described herein, a transpose for a 16 b weight mode may differ from a transpose for an 8 b weight mode. FIG. 16 further illustrates how the resulting weight memories in FIG. 18 may be fed to respective MAC units.

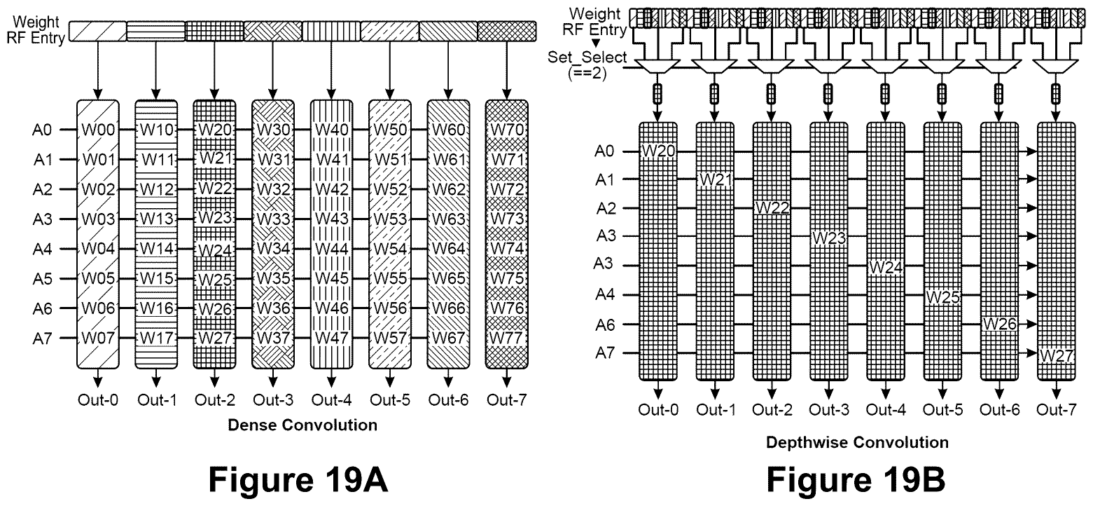

FIG. 19A illustrates an example dense convolution. In a dense convolution, activations and corresponding weights may be processed, and each channel (e.g., column) may be accumulated for an output. In other words, each row may use its own activation value, and each column may use its own weight value for each row value, and each column may then be accumulated, similar to a row multiplied with a matrix.

FIG. 19B illustrates an example depthwise convolution. In a depthwise convolution, a single entry per multiply-accumulate (MAC) column may be passed to the compute unit, as illustrated in FIG. 19B. In other words, each row may use its own activation value and each column may use its own weight value, similar to a row multiplied with a column. However, for a depthwise convolution, using split operands (e.g., 16 b operand split into two 8 b operands) may require reduction/accumulation.

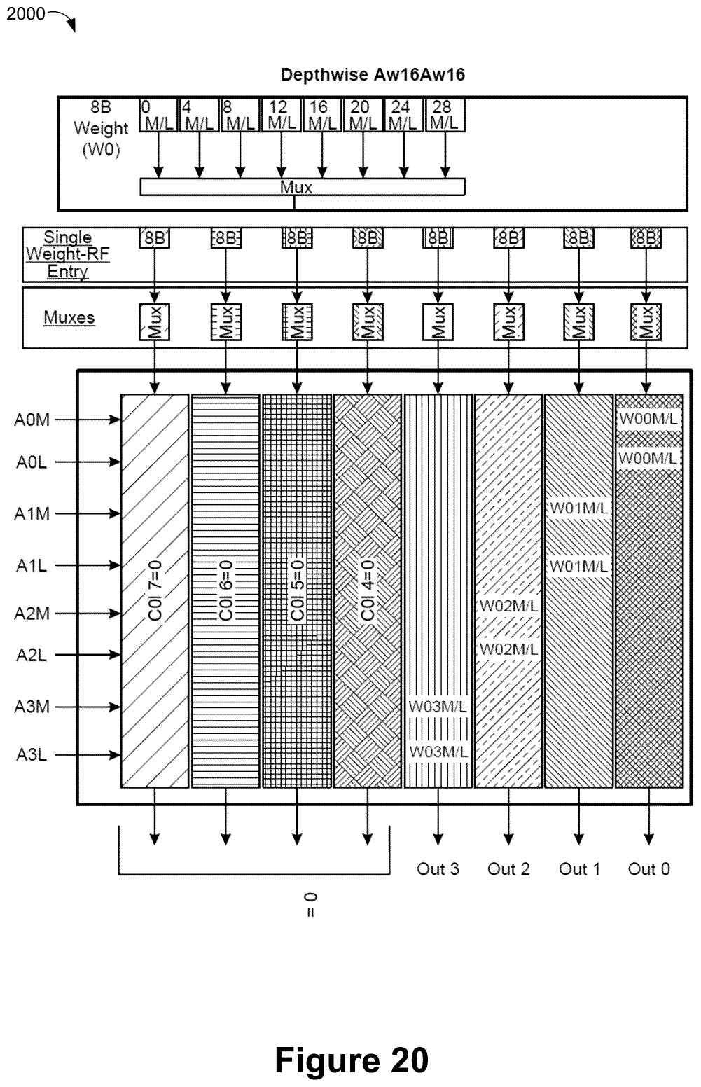

FIG. 20 illustrates an example depthwise convolution with weight packing and splitting 2000. FIG. 20 illustrates how full weights (e.g., 16 b) may be split into 8 b portions (e.g., MSB/LSB) and provided to MAC arrays. For example, weight values may be read (e.g., as described herein) into columns. For example, on a first iteration and/or cycle, the MSB bits (represented as “M” in FIG. 20) may be used. The activation values may also be split into MSB and LSB (represented as “L” in FIG. 20) portions as described herein. Thus, for a split activation value, the pair may be accumulated in the same column using this MAC array architecture. In such an architecture, certain columns (e.g., columns 4-7 in FIG. 20) may be unused and accordingly disabled for power savings. On a subsequent cycle and/or separate iteration, the LSB weight values and same weight values may be processed, and the corresponding elements of the two result sets may be reduced as described herein.

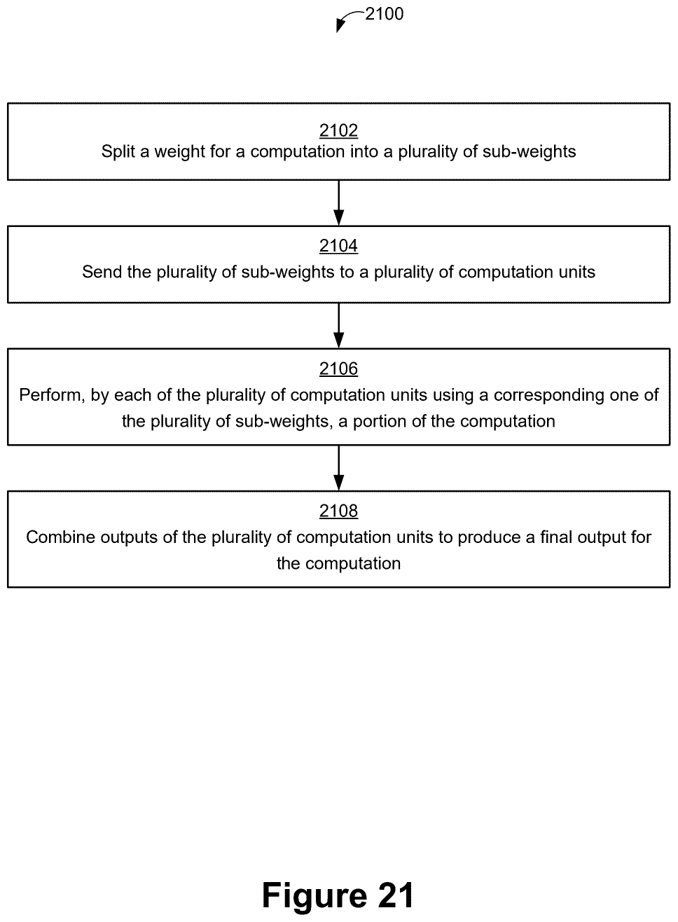

FIG. 21 illustrates a flow diagram of a method for spatially distributed computation, in accordance with some embodiments. Operations (e.g., steps) of the method 2100 can be performed by one or more processors (e.g., central processing unit and/or MCU) of a system (e.g., an XR system described in below in reference to FIGS. 22A-22C-2). At least some of the operations shown in FIG. 21 correspond to instructions stored in a computer memory or computer-readable storage medium (e.g., storage, RAM, and/or memory). Operations of the method 2100 can be performed by a single device alone or in conjunction with one or more processors and/or hardware components of another communicatively coupled device (e.g., one or more devices of an XR system described below in reference to FIGS. 22A-22C-2) and/or instructions stored in memory or computer-readable medium of the other device communicatively coupled to the system. In some embodiments, the various operations of the methods described herein are interchangeable and/or optional, and respective operations of the methods are performed by any of the aforementioned devices, systems, or combination of devices and/or systems. For convenience, the method operations will be described below as being performed by particular component or device, but should not be construed as limiting the performance of the operation to the particular device in all embodiments.
(B1) A method 2100 occurs at a computing device including memory and one or more processors. The method 2100 includes splitting (2102) a weight for a computation into a plurality of sub-weights. The method 2100 includes sending (2104) the plurality of sub-weights to a plurality of computation units and performing (2106), by each of the plurality of computation units using a corresponding one of the plurality of sub-weights, a portion of the computation. The method 2100 further includes combining (2108) outputs of the plurality of computation units to produce a final output for the computation.
(B2) In some embodiments of B1, splitting the weight comprises splitting the weight into a most significant bit (MSB) portion and a least significant bit (LSB) portion.
(B3) In some embodiments of any one of B1-B2, combining the outputs includes shifting an output from the MSB portion and adding an output from the LSB portion with the shifted output from the MSB portion.
(B4) In some embodiments of any one of B1-B3, the LSB portion is unsigned.
(B5) In some embodiments of any one of B1-B4, the plurality of computation units perform respective portions of the computation in parallel.
(B6) In some embodiments of any one of B1-B5, a direct memory access (DMA) engine is configured to read a weight for a computation and split the weight into a plurality of sub-weights.
(B7) In some embodiments of any one of B1-B6, a reduction unit is configured to receive outputs from each of the plurality of computation units and combine the outputs into a final output for the computation.
(B8) In some embodiments of any one of B1-B7, a at least one of the plurality of computation units is configured to duplicate a received weight value.
(C1) In accordance with some embodiments, a system that includes one or more wrist wearable devices and a pair of augmented-reality glasses, and the system is configured to perform operations corresponding to any of A1-B8.
(D1) In accordance with some embodiments, a non-transitory computer readable storage medium including instructions that, when executed by a computing device, cause the computer device to perform operations corresponding to any of A1-B8.
(E1) In accordance with some embodiments, a means for performing or causing performance of operations corresponding to any of A1-B8.
(F1) In accordance with some embodiments, an intermediary processing device, a wrist-wearable device, and/or a head-wearable device configured to perform or cause performance of operations corresponding to any of A1-B8.

The devices described above are further detailed below, including wrist-wearable devices, headset devices, systems, and haptic feedback devices. Specific operations described above may occur as a result of specific hardware, such hardware is described in further detail below. The devices described below are not limiting and features on these devices can be removed or additional features can be added to these devices.

### Example Extended-Reality Systems

FIGS. 22A, 22B, 22C-1, and 22C-2, illustrate example XR systems that include AR and MR systems, in accordance with some embodiments. FIG. 22A shows a first XR system 2200a and first example user interactions using a wrist-wearable device 2226, a head-wearable device (e.g., AR device 2228), and/or a HIPD 2242. FIG. 22B shows a second XR system 2200b and second example user interactions using a wrist-wearable device 2226, AR device 2228, and/or an HIPD 2242. FIGS. 22C-1 and 22C-2 show a third MR system 2200c and third example user interactions using a wrist-wearable device 2226, a head-wearable device (e.g., an MR device such as a VR device), and/or an HIPD 2242. As the skilled artisan will appreciate upon reading the descriptions provided herein, the above-example AR and MR systems (described in detail below) can perform various functions and/or operations.

The wrist-wearable device 2226, the head-wearable devices, and/or the HIPD 2242 can communicatively couple via a network 2225 (e.g., cellular, near field, Wi-Fi, personal area network, wireless LAN). Additionally, the wrist-wearable device 2226, the head-wearable device, and/or the HIPD 2242 can also communicatively couple with one or more servers 2230, computers 2240 (e.g., laptops, computers), mobile devices 2250 (e.g., smartphones, tablets), and/or other electronic devices via the network 2225 (e.g., cellular, near field, Wi-Fi, personal area network, wireless LAN). Similarly, a smart textile-based garment, when used, can also communicatively couple with the wrist-wearable device 2226, the head-wearable device(s), the HIPD 2242, the one or more servers 2230, the computers 2240, the mobile devices 2250, and/or other electronic devices via the network 2225 to provide inputs.

Turning to FIG. 22A, a user 2202 is shown wearing the wrist-wearable device 2226 and the AR device 2228 and having the HIPD 2242 on their desk. The wrist-wearable device 2226, the AR device 2228, and the HIPD 2242 facilitate user interaction with an AR environment. In particular, as shown by the first AR system 2200a, the wrist-wearable device 2226, the AR device 2228, and/or the HIPD 2242 cause presentation of one or more avatars 2204, digital representations of contacts 2206, and virtual objects 2208. As discussed below, the user 2202 can interact with the one or more avatars 2204, digital representations of the contacts 2206, and virtual objects 2208 via the wrist-wearable device 2226, the AR device 2228, and/or the HIPD 2242. In addition, the user 2202 is also able to directly view physical objects in the environment, such as a physical table 2229, through transparent lens(es) and waveguide(s) of the AR device 2228. Alternatively, an MR device could be used in place of the AR device 2228 and a similar user experience can take place, but the user would not be directly viewing physical objects in the environment, such as table 2229, and would instead be presented with a virtual reconstruction of the table 2229 produced from one or more sensors of the MR device (e.g., an outward facing camera capable of recording the surrounding environment).

The user 2202 can use any of the wrist-wearable device 2226, the AR device 2228 (e.g., through physical inputs at the AR device and/or built-in motion tracking of a user's extremities), a smart-textile garment, externally mounted extremity tracking device, the HIPD 2242 to provide user inputs, etc. For example, the user 2202 can perform one or more hand gestures that are detected by the wrist-wearable device 2226 (e.g., using one or more EMG sensors and/or IMUs built into the wrist-wearable device) and/or AR device 2228 (e.g., using one or more image sensors or cameras) to provide a user input. Alternatively, or additionally, the user 2202 can provide a user input via one or more touch surfaces of the wrist-wearable device 2226, the AR device 2228, and/or the HIPD 2242, and/or voice commands captured by a microphone of the wrist-wearable device 2226, the AR device 2228, and/or the HIPD 2242. The wrist-wearable device 2226, the AR device 2228, and/or the HIPD 2242 include an artificially intelligent digital assistant to help the user in providing a user input (e.g., completing a sequence of operations, suggesting different operations or commands, providing reminders, confirming a command). For example, the digital assistant can be invoked through an input occurring at the AR device 2228 (e.g., via an input at a temple arm of the AR device 2228). In some embodiments, the user 2202 can provide a user input via one or more facial gestures and/or facial expressions. For example, cameras of the wrist-wearable device 2226, the AR device 2228, and/or the HIPD 2242 can track the user 2202's eyes for navigating a user interface.

The wrist-wearable device 2226, the AR device 2228, and/or the HIPD 2242 can operate alone or in conjunction to allow the user 2202 to interact with the AR environment. In some embodiments, the HIPD 2242 is configured to operate as a central hub or control center for the wrist-wearable device 2226, the AR device 2228, and/or another communicatively coupled device. For example, the user 2202 can provide an input to interact with the AR environment at any of the wrist-wearable device 2226, the AR device 2228, and/or the HIPD 2242, and the HIPD 2242 can identify one or more back-end and front-end tasks to cause the performance of the requested interaction and distribute instructions to cause the performance of the one or more back-end and front-end tasks at the wrist-wearable device 2226, the AR device 2228, and/or the HIPD 2242. In some embodiments, a back-end task is a background-processing task that is not perceptible by the user (e.g., rendering content, decompression, compression, application-specific operations), and a front-end task is a user-facing task that is perceptible to the user (e.g., presenting information to the user, providing feedback to the user). The HIPD 2242 can perform the back-end tasks and provide the wrist-wearable device 2226 and/or the AR device 2228 operational data corresponding to the performed back-end tasks such that the wrist-wearable device 2226 and/or the AR device 2228 can perform the front-end tasks. In this way, the HIPD 2242, which has more computational resources and greater thermal headroom than the wrist-wearable device 2226 and/or the AR device 2228, performs computationally intensive tasks and reduces the computer resource utilization and/or power usage of the wrist-wearable device 2226 and/or the AR device 2228.

In the example shown by the first AR system 2200a, the HIPD 2242 identifies one or more back-end tasks and front-end tasks associated with a user request to initiate an AR video call with one or more other users (represented by the avatar 2204 and the digital representation of the contact 2206) and distributes instructions to cause the performance of the one or more back-end tasks and front-end tasks. In particular, the HIPD 2242 performs back-end tasks for processing and/or rendering image data (and other data) associated with the AR video call and provides operational data associated with the performed back-end tasks to the AR device 2228 such that the AR device 2228 performs front-end tasks for presenting the AR video call (e.g., presenting the avatar 2204 and the digital representation of the contact 2206).

In some embodiments, the HIPD 2242 can operate as a focal or anchor point for causing the presentation of information. This allows the user 2202 to be generally aware of where information is presented. For example, as shown in the first AR system 2200a, the avatar 2204 and the digital representation of the contact 2206 are presented above the HIPD 2242. In particular, the HIPD 2242 and the AR device 2228 operate in conjunction to determine a location for presenting the avatar 2204 and the digital representation of the contact 2206. In some embodiments, information can be presented within a predetermined distance from the HIPD 2242 (e.g., within five meters). For example, as shown in the first AR system 2200a, virtual object 2208 is presented on the desk some distance from the HIPD 2242. Similar to the above example, the HIPD 2242 and the AR device 2228 can operate in conjunction to determine a location for presenting the virtual object 2208. Alternatively, in some embodiments, presentation of information is not bound by the HIPD 2242. More specifically, the avatar 2204, the digital representation of the contact 2206, and the virtual object 2208 do not have to be presented within a predetermined distance of the HIPD 2242. While an AR device 2228 is described working with an HIPD, an MR headset can be interacted with in the same way as the AR device 2228.

User inputs provided at the wrist-wearable device 2226, the AR device 2228, and/or the HIPD 2242 are coordinated such that the user can use any device to initiate, continue, and/or complete an operation. For example, the user 2202 can provide a user input to the AR device 2228 to cause the AR device 2228 to present the virtual object 2208 and, while the virtual object 2208 is presented by the AR device 2228, the user 2202 can provide one or more hand gestures via the wrist-wearable device 2226 to interact and/or manipulate the virtual object 2208. While an AR device 2228 is described working with a wrist-wearable device 2226, an MR headset can be interacted with in the same way as the AR device 2228.

Integration of Artificial Intelligence with XR Systems

FIG. 22A illustrates an interaction in which an artificially intelligent virtual assistant can assist in requests made by a user 2202. The AI virtual assistant can be used to complete open-ended requests made through natural language inputs by a user 2202. For example, in FIG. 22A the user 2202 makes an audible request 2244 to summarize the conversation and then share the summarized conversation with others in the meeting. In addition, the AI virtual assistant is configured to use sensors of the XR system (e.g., cameras of an XR headset, microphones, and various other sensors of any of the devices in the system) to provide contextual prompts to the user for initiating tasks.

FIG. 22A also illustrates an example neural network 2252 used in Artificial Intelligence applications. Uses of Artificial Intelligence (AI) are varied and encompass many different aspects of the devices and systems described herein. AI capabilities cover a diverse range of applications and deepen interactions between the user 2202 and user devices (e.g., the AR device 2228, an MR device 2232, the HIPD 2242, the wrist-wearable device 2226). The AI discussed herein can be derived using many different training techniques. While the primary AI model example discussed herein is a neural network, other AI models can be used. Non-limiting examples of AI models include artificial neural networks (ANNs), deep neural networks (DNNs), convolution neural networks (CNNs), recurrent neural networks (RNNs), large language models (LLMs), long short-term memory networks, transformer models, decision trees, random forests, support vector machines, k-nearest neighbors, genetic algorithms, Markov models, Bayesian networks, fuzzy logic systems, and deep reinforcement learnings, etc. The AI models can be implemented at one or more of the user devices, and/or any other devices described herein. For devices and systems herein that employ multiple AI models, different models can be used depending on the task. For example, for a natural-language artificially intelligent virtual assistant, an LLM can be used and for the object detection of a physical environment, a DNN can be used instead.

In another example, an AI virtual assistant can include many different AI models and based on the user's request, multiple AI models may be employed (concurrently, sequentially or a combination thereof). For example, an LLM-based AI model can provide instructions for helping a user follow a recipe and the instructions can be based in part on another AI model that is derived from an ANN, a DNN, an RNN, etc. that is capable of discerning what part of the recipe the user is on (e.g., object and scene detection).

As AI training models evolve, the operations and experiences described herein could potentially be performed with different models other than those listed above, and a person skilled in the art would understand that the list above is non-limiting.

A user 2202 can interact with an AI model through natural language inputs captured by a voice sensor, text inputs, or any other input modality that accepts natural language and/or a corresponding voice sensor module. In another instance, input is provided by tracking the eye gaze of a user 2202 via a gaze tracker module. Additionally, the AI model can also receive inputs beyond those supplied by a user 2202. For example, the AI can generate its response further based on environmental inputs (e.g., temperature data, image data, video data, ambient light data, audio data, GPS location data, inertial measurement (i.e., user motion) data, pattern recognition data, magnetometer data, depth data, pressure data, force data, neuromuscular data, heart rate data, temperature data, sleep data) captured in response to a user request by various types of sensors and/or their corresponding sensor modules. The sensors' data can be retrieved entirely from a single device (e.g., AR device 2228) or from multiple devices that are in communication with each other (e.g., a system that includes at least two of an AR device 2228, an MR device 2232, the HIPD 2242, the wrist-wearable device 2226, etc.). The AI model can also access additional information (e.g., one or more servers 2230, the computers 2240, the mobile devices 2250, and/or other electronic devices) via a network 2225.

A non-limiting list of AI-enhanced functions includes but is not limited to image recognition, speech recognition (e.g., automatic speech recognition), text recognition (e.g., scene text recognition), pattern recognition, natural language processing and understanding, classification, regression, clustering, anomaly detection, sequence generation, content generation, and optimization. In some embodiments, AI-enhanced functions are fully or partially executed on cloud-computing platforms communicatively coupled to the user devices (e.g., the AR device 2228, an MR device 2232, the HIPD 2242, the wrist-wearable device 2226) via the one or more networks. The cloud-computing platforms provide scalable computing resources, distributed computing, managed AI services, interference acceleration, pre-trained models, APIs and/or other resources to support comprehensive computations required by the AI-enhanced function.

Example outputs stemming from the use of an AI model can include natural language responses, mathematical calculations, charts displaying information, audio, images, videos, texts, summaries of meetings, predictive operations based on environmental factors, classifications, pattern recognitions, recommendations, assessments, or other operations. In some embodiments, the generated outputs are stored on local memories of the user devices (e.g., the AR device 2228, an MR device 2232, the HIPD 2242, the wrist-wearable device 2226), storage options of the external devices (servers, computers, mobile devices, etc.), and/or storage options of the cloud-computing platforms.

The AI-based outputs can be presented across different modalities (e.g., audio-based, visual-based, haptic-based, and any combination thereof) and across different devices of the XR system described herein. Some visual-based outputs can include the displaying of information on XR augments of an XR headset, user interfaces displayed at a wrist-wearable device, laptop device, mobile device, etc. On devices with or without displays (e.g., HIPD 2242), haptic feedback can provide information to the user 2202. An AI model can also use the inputs described above to determine the appropriate modality and device(s) to present content to the user (e.g., a user walking on a busy road can be presented with an audio output instead of a visual output to avoid distracting the user 2202).

### Example Augmented Reality Interaction

FIG. 22B shows the user 2202 wearing the wrist-wearable device 2226 and the AR device 2228 and holding the HIPD 2242. In the second AR system 2200b, the wrist-wearable device 2226, the AR device 2228, and/or the HIPD 2242 are used to receive and/or provide one or more messages to a contact of the user 2202. In particular, the wrist-wearable device 2226, the AR device 2228, and/or the HIPD 2242 detect and coordinate one or more user inputs to initiate a messaging application and prepare a response to a received message via the messaging application.

In some embodiments, the user 2202 initiates, via a user input, an application on the wrist-wearable device 2226, the AR device 2228, and/or the HIPD 2242 that causes the application to initiate on at least one device. For example, in the second AR system 2200b the user 2202 performs a hand gesture associated with a command for initiating a messaging application (represented by messaging user interface 2212); the wrist-wearable device 2226 detects the hand gesture; and, based on a determination that the user 2202 is wearing the AR device 2228, causes the AR device 2228 to present a messaging user interface 2212 of the messaging application. The AR device 2228 can present the messaging user interface 2212 to the user 2202 via its display (e.g., as shown by user 2202's field of view 2210). In some embodiments, the application is initiated and can be run on the device (e.g., the wrist-wearable device 2226, the AR device 2228, and/or the HIPD 2242) that detects the user input to initiate the application, and the device provides another device operational data to cause the presentation of the messaging application. For example, the wrist-wearable device 2226 can detect the user input to initiate a messaging application, initiate and run the messaging application, and provide operational data to the AR device 2228 and/or the HIPD 2242 to cause presentation of the messaging application. Alternatively, the application can be initiated and run at a device other than the device that detected the user input. For example, the wrist-wearable device 2226 can detect the hand gesture associated with initiating the messaging application and cause the HIPD 2242 to run the messaging application and coordinate the presentation of the messaging application.

Further, the user 2202 can provide a user input provided at the wrist-wearable device 2226, the AR device 2228, and/or the HIPD 2242 to continue and/or complete an operation initiated at another device. For example, after initiating the messaging application via the wrist-wearable device 2226 and while the AR device 2228 presents the messaging user interface 2212, the user 2202 can provide an input at the HIPD 2242 to prepare a response (e.g., shown by the swipe gesture performed on the HIPD 2242). The user 2202's gestures performed on the HIPD 2242 can be provided and/or displayed on another device. For example, the user 2202's swipe gestures performed on the HIPD 2242 are displayed on a virtual keyboard of the messaging user interface 2212 displayed by the AR device 2228.

In some embodiments, the wrist-wearable device 2226, the AR device 2228, the HIPD 2242, and/or other communicatively coupled devices can present one or more notifications to the user 2202. The notification can be an indication of a new message, an incoming call, an application update, a status update, etc. The user 2202 can select the notification via the wrist-wearable device 2226, the AR device 2228, or the HIPD 2242 and cause presentation of an application or operation associated with the notification on at least one device. For example, the user 2202 can receive a notification that a message was received at the wrist-wearable device 2226, the AR device 2228, the HIPD 2242, and/or other communicatively coupled device and provide a user input at the wrist-wearable device 2226, the AR device 2228, and/or the HIPD 2242 to review the notification, and the device detecting the user input can cause an application associated with the notification to be initiated and/or presented at the wrist-wearable device 2226, the AR device 2228, and/or the HIPD 2242.

While the above example describes coordinated inputs used to interact with a messaging application, the skilled artisan will appreciate upon reading the descriptions that user inputs can be coordinated to interact with any number of applications including, but not limited to, gaming applications, social media applications, camera applications, web-based applications, financial applications, etc. For example, the AR device 2228 can present to the user 2202 game application data and the HIPD 2242 can use a controller to provide inputs to the game. Similarly, the user 2202 can use the wrist-wearable device 2226 to initiate a camera of the AR device 2228, and the user can use the wrist-wearable device 2226, the AR device 2228, and/or the HIPD 2242 to manipulate the image capture (e.g., zoom in or out, apply filters) and capture image data.

While an AR device 2228 is shown being capable of certain functions, it is understood that an AR device can be an AR device with varying functionalities based on costs and market demands. For example, an AR device may include a single output modality such as an audio output modality. In another example, the AR device may include a low-fidelity display as one of the output modalities, where simple information (e.g., text and/or low-fidelity images/video) is capable of being presented to the user. In yet another example, the AR device can be configured with face-facing light emitting diodes (LEDs) configured to provide a user with information, e.g., an LED around the right-side lens can illuminate to notify the wearer to turn right while directions are being provided or an LED on the left-side can illuminate to notify the wearer to turn left while directions are being provided. In another embodiment, the AR device can include an outward-facing projector such that information (e.g., text information, media) may be displayed on the palm of a user's hand or other suitable surface (e.g., a table, whiteboard). In yet another embodiment, information may also be provided by locally dimming portions of a lens to emphasize portions of the environment in which the user's attention should be directed. Some AR devices can present AR augments either monocularly or binocularly (e.g., an AR augment can be presented at only a single display associated with a single lens as opposed presenting an AR augmented at both lenses to produce a binocular image). In some instances an AR device capable of presenting AR augments binocularly can optionally display AR augments monocularly as well (e.g., for power-saving purposes or other presentation considerations). These examples are non-exhaustive and features of one AR device described above can be combined with features of another AR device described above. While features and experiences of an AR device have been described generally in the preceding sections, it is understood that the described functionalities and experiences can be applied in a similar manner to an MR headset, which is described below in the proceeding sections.

### Example Mixed Reality Interaction

Turning to FIGS. 22C-1 and 22C-2, the user 2202 is shown wearing the wrist-wearable device 2226 and an MR device 2232 (e.g., a device capable of providing either an entirely VR experience or an MR experience that displays object(s) from a physical environment at a display of the device) and holding the HIPD 2242. In the third AR system 2200c, the wrist-wearable device 2226, the MR device 2232, and/or the HIPD 2242 are used to interact within an MR environment, such as a VR game or other MR/VR application. While the MR device 2232 presents a representation of a VR game (e.g., first MR game environment 2220) to the user 2202, the wrist-wearable device 2226, the MR device 2232, and/or the HIPD 2242 detect and coordinate one or more user inputs to allow the user 2202 to interact with the VR game.

In some embodiments, the user 2202 can provide a user input via the wrist-wearable device 2226, the MR device 2232, and/or the HIPD 2242 that causes an action in a corresponding MR environment. For example, the user 2202 in the third MR system 2200c (shown in FIG. 22C-1) raises the HIPD 2242 to prepare for a swing in the first MR game environment 2220. The MR device 2232, responsive to the user 2202 raising the HIPD 2242, causes the MR representation of the user 2222 to perform a similar action (e.g., raise a virtual object, such as a virtual sword 2224). In some embodiments, each device uses respective sensor data and/or image data to detect the user input and provide an accurate representation of the user 2202's motion. For example, image sensors (e.g., SLAM cameras or other cameras) of the HIPD 2242 can be used to detect a position of the HIPD 2242 relative to the user 2202's body such that the virtual object can be positioned appropriately within the first MR game environment 2220; sensor data from the wrist-wearable device 2226 can be used to detect a velocity at which the user 2202 raises the HIPD 2242 such that the MR representation of the user 2222 and the virtual sword 2224 are synchronized with the user 2202's movements; and image sensors of the MR device 2232 can be used to represent the user 2202's body, boundary conditions, or real-world objects within the first MR game environment 2220.

In FIG. 22C-2, the user 2202 performs a downward swing while holding the HIPD 2242. The user 2202's downward swing is detected by the wrist-wearable device 2226, the MR device 2232, and/or the HIPD 2242 and a corresponding action is performed in the first MR game environment 2220. In some embodiments, the data captured by each device is used to improve the user's experience within the MR environment. For example, sensor data of the wrist-wearable device 2226 can be used to determine a speed and/or force at which the downward swing is performed and image sensors of the HIPD 2242 and/or the MR device 2232 can be used to determine a location of the swing and how it should be represented in the first MR game environment 2220, which, in turn, can be used as inputs for the MR environment (e.g., game mechanics, which can use detected speed, force, locations, and/or aspects of the user 2202's actions to classify a user's inputs (e.g., user performs a light strike, hard strike, critical strike, glancing strike, miss) or calculate an output (e.g., amount of damage)).

FIG. 22C-2 further illustrates that a portion of the physical environment is reconstructed and displayed at a display of the MR device 2232 while the MR game environment 2220 is being displayed. In this instance, a reconstruction of the physical environment 2246 is displayed in place of a portion of the MR game environment 2220 when object(s) in the physical environment are potentially in the path of the user (e.g., a collision with the user and an object in the physical environment are likely). Thus, this example MR game environment 2220 includes (i) an immersive VR portion 2248 (e.g., an environment that does not have a corollary counterpart in a nearby physical environment) and (ii) a reconstruction of the physical environment 2246 (e.g., table 2250 and cup 2252). While the example shown here is an MR environment that shows a reconstruction of the physical environment to avoid collisions, other uses of reconstructions of the physical environment can be used, such as defining features of the virtual environment based on the surrounding physical environment (e.g., a virtual column can be placed based on an object in the surrounding physical environment (e.g., a tree)).

While the wrist-wearable device 2226, the MR device 2232, and/or the HIPD 2242 are described as detecting user inputs, in some embodiments, user inputs are detected at a single device (with the single device being responsible for distributing signals to the other devices for performing the user input). For example, the HIPD 2242 can operate an application for generating the first MR game environment 2220 and provide the MR device 2232 with corresponding data for causing the presentation of the first MR game environment 2220, as well as detect the user 2202's movements (while holding the HIPD 2242) to cause the performance of corresponding actions within the first MR game environment 2220. Additionally or alternatively, in some embodiments, operational data (e.g., sensor data, image data, application data, device data, and/or other data) of one or more devices is provided to a single device (e.g., the HIPD 2242) to process the operational data and cause respective devices to perform an action associated with processed operational data.

In some embodiments, the user 2202 can wear a wrist-wearable device 2226, wear an MR device 2232, wear smart textile-based garments 2238 (e.g., wearable haptic gloves), and/or hold an HIPD 2242 device. In this embodiment, the wrist-wearable device 2226, the MR device 2232, and/or the smart textile-based garments 2238 are used to interact within an MR environment (e.g., any AR or MR system described above in reference to FIGS. 22A-22B). While the MR device 2232 presents a representation of an MR game (e.g., second MR game environment 2220) to the user 2202, the wrist-wearable device 2226, the MR device 2232, and/or the smart textile-based garments 2238 detect and coordinate one or more user inputs to allow the user 2202 to interact with the MR environment.

In some embodiments, the user 2202 can provide a user input via the wrist-wearable device 2226, an HIPD 2242, the MR device 2232, and/or the smart textile-based garments 2238 that causes an action in a corresponding MR environment. In some embodiments, each device uses respective sensor data and/or image data to detect the user input and provide an accurate representation of the user 2202's motion. While four different input devices are shown (e.g., a wrist-wearable device 2226, an MR device 2232, an HIPD 2242, and a smart textile-based garment 2238) each one of these input devices entirely on its own can provide inputs for fully interacting with the MR environment. For example, the wrist-wearable device can provide sufficient inputs on its own for interacting with the MR environment. In some embodiments, if multiple input devices are used (e.g., a wrist-wearable device and the smart textile-based garment 2238) sensor fusion can be utilized to ensure inputs are correct. While multiple input devices are described, it is understood that other input devices can be used in conjunction or on their own instead, such as but not limited to external motion-tracking cameras, other wearable devices fitted to different parts of a user, apparatuses that allow for a user to experience walking in an MR environment while remaining substantially stationary in the physical environment, etc.

As described above, the data captured by each device is used to improve the user's experience within the MR environment. Although not shown, the smart textile-based garments 2238 can be used in conjunction with an MR device and/or an HIPD 2242.

While some experiences are described as occurring on an AR device and other experiences are described as occurring on an MR device, one skilled in the art would appreciate that experiences can be ported over from an MR device to an AR device, and vice versa.

### Other Interactions

While numerous examples are described in this application related to extended-reality environments, one skilled in the art would appreciate that certain interactions may be possible with other devices. For example, a user may interact with a robot (e.g., a humanoid robot, a task specific robot, or other type of robot) to perform tasks inclusive of, leading to, and/or otherwise related to the tasks described herein. In some embodiments, these tasks can be user specific and learned by the robot based on training data supplied by the user and/or from the user's wearable devices (including head-worn and wrist-worn, among others) in accordance with techniques described herein. As one example, this training data can be received from the numerous devices described in this application (e.g., from sensor data and user-specific interactions with head-wearable devices, wrist-wearable devices, intermediary processing devices, or any combination thereof). Other data sources are also conceived outside of the devices described here. For example, AI models for use in a robot can be trained using a blend of user-specific data and non-user specific-aggregate data. The robots may also be able to perform tasks wholly unrelated to extended reality environments, and can be used for performing quality-of-life tasks (e.g., performing chores, completing repetitive operations, etc.). In certain embodiments or circumstances, the techniques and/or devices described herein can be integrated with and/or otherwise performed by the robot.

Some definitions of devices and components that can be included in some or all of the example devices discussed are defined here for ease of reference. A skilled artisan will appreciate that certain types of the components described may be more suitable for a particular set of devices, and less suitable for a different set of devices. But subsequent reference to the components defined here should be considered to be encompassed by the definitions provided.

In some embodiments example devices and systems, including electronic devices and systems, will be discussed. Such example devices and systems are not intended to be limiting, and one of skill in the art will understand that alternative devices and systems to the example devices and systems described herein may be used to perform the operations and construct the systems and devices that are described herein.

As described herein, an electronic device is a device that uses electrical energy to perform a specific function. It can be any physical object that contains electronic components such as transistors, resistors, capacitors, diodes, and integrated circuits. Examples of electronic devices include smartphones, laptops, digital cameras, televisions, gaming consoles, and music players, as well as the example electronic devices discussed herein. As described herein, an intermediary electronic device is a device that sits between two other electronic devices, and/or a subset of components of one or more electronic devices and facilitates communication, and/or data processing and/or data transfer between the respective electronic devices and/or electronic components.

The foregoing descriptions of FIGS. 22A-22C-2 provided above are intended to augment the description provided in reference to FIGS. 1-21. While terms in the following description may not be identical to terms used in the foregoing description, a person having ordinary skill in the art would understand these terms to have the same meaning.

Any data collection performed by the devices described herein and/or any devices configured to perform or cause the performance of the different embodiments described above in reference to any of the Figures, hereinafter the “devices,” is done with user consent and in a manner that is consistent with all applicable privacy laws. Users are given options to allow the devices to collect data, as well as the option to limit or deny collection of data by the devices. A user is able to opt in or opt out of any data collection at any time. Further, users are given the option to request the removal of any collected data.

It will be understood that, although the terms “first,” “second,” etc. may be used herein to describe various elements, these elements should not be limited by these terms. These terms are only used to distinguish one element from another.

The terminology used herein is for the purpose of describing particular embodiments only and is not intended to be limiting of the claims. As used in the description of the embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” can be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” can be construed to mean “upon determining” or “in response to determining” or “in accordance with a determination” or “upon detecting” or “in response to detecting” that the stated condition precedent is true, depending on the context.

The foregoing description, for purpose of explanation, has been described with reference to specific embodiments. However, the illustrative discussions above are not intended to be exhaustive or to limit the claims to the precise forms disclosed. Many modifications and variations are possible in view of the above teachings. The embodiments were chosen and described in order to best explain principles of operation and practical applications, to thereby enable others skilled in the art.

What is claimed is:

1. A non-transitory, computer-readable storage medium including executable instructions that, when executed by one or more processors, cause the one or more processors to perform or cause performance of:
receiving a tensor;
compressing the tensor by applying a compression scheme to values of the tensor to form a compressed tensor;
storing the compressed tensor into a tensor cache;
reading the compressed tensor from the tensor cache;
decompressing the compressed tensor by applying a decompression scheme to values of the compressed tensor to form a decompressed tensor; and
forwarding the decompressed tensor to a compute unit.

2. The non-transitory, computer-readable storage medium of claim 1, wherein the compression scheme is indicated by a compression flag in an instruction for storing the tensor.

3. The non-transitory, computer-readable storage medium of claim 1, wherein the compression scheme corresponds to quantizing an integer into a quantized floating-point format having a reduced bit size.

4. The non-transitory, computer-readable storage medium of claim 3, wherein the quantized floating-point format retains a sign bit of the integer.

5. The non-transitory, computer-readable storage medium of claim 3, wherein the quantized floating-point format includes an exponent portion corresponding to a position of a non-zero most significant bit (MSB) of the integer.

6. The non-transitory, computer-readable storage medium of claim 5, wherein the compression scheme includes determining the exponent portion for each integer value.

7. The non-transitory, computer-readable storage medium of claim 5, wherein the compression scheme includes determining the exponent portion for a group of integer values.

8. The non-transitory, computer-readable storage medium of claim 3, wherein the quantized floating-point format includes a mantissa portion corresponding to a value of a non-zero most significant bit (MSB) of the integer.

9. A system, comprising:
a wearable device; and
memory including one or more programs that are configured to be executed by one or more processors in communication with the wearable device, the one or more programs including instructions for:
receiving a tensor;
compressing the tensor by applying a compression scheme to values of the tensor to form a compressed tensor;
storing the compressed tensor into a tensor cache;
reading the compressed tensor from the tensor cache;
decompressing the compressed tensor by applying a decompression scheme to values of the compressed tensor to form a decompressed tensor; and
forwarding the decompressed tensor to a compute unit.

10. The system of claim 9, wherein the compression scheme is indicated by a compression flag in an instruction for storing the tensor.

11. The system of claim 9, wherein the compression scheme corresponds to quantizing an integer into a quantized floating-point format having a reduced bit size.

12. The system of claim 11, wherein the quantized floating-point format retains a sign bit of the integer.

13. The system of claim 11, wherein the quantized floating-point format includes an exponent portion corresponding to a position of a non-zero most significant bit (MSB) of the integer.

14. The system of claim 13, wherein the compression scheme includes determining the exponent portion for each integer value.

15. A method, comprising:
receiving a tensor;
compressing the tensor by applying a compression scheme to values of the tensor to form a compressed tensor;
storing the compressed tensor into a tensor cache;
reading the compressed tensor from the tensor cache;
decompressing the compressed tensor by applying a decompression scheme to values of the compressed tensor to form a decompressed tensor; and
forwarding the decompressed tensor to a compute unit.

16. The method of claim 15, wherein the compression scheme is indicated by a compression flag in an instruction for storing the tensor.

17. The method of claim 15, wherein the compression scheme corresponds to quantizing an integer into a quantized floating-point format having a reduced bit size.

18. The method of claim 17, wherein the quantized floating-point format retains a sign bit of the integer.

19. The method of claim 17, wherein the quantized floating-point format includes an exponent portion corresponding to a position of a non-zero most significant bit (MSB) of the integer.

20. The method of claim 19, wherein the compression scheme includes determining the exponent portion for each integer value.
